(19) United States
(12) Patent Application Publication
(10) Pub. No.: US 2026/0246665 A1
(43) Pub. Date: Aug. 20, 2026

(54) CAPABILITY-BASED MACHINE LEARNING MODEL QUANTIZATION

(71) Applicant: QUALCOMM Incorporated, San Diego, CA (US)

(72) Inventors: Yuwei REN, Beijing (CN); Tianyang BAI, Somerville, NJ (US)

(21) Appl. No.: 19/164,372

(22) PCT Filed: Apr. 21, 2023
(86) PCT No.: PCT/CN2023/089708

§ 371 Date: Sep. 11, 2025

(51) Int. Cl. H04L 25/02; H04L 41/16

(52) U.S. Cl. CPC H04L 25/0202; H04L 41/16

(57) ABSTRACT

Methods, systems, and devices for wireless communications are described. The described techniques relate to improved methods, systems, devices, and apparatuses that support capability-based machine learning (ML) model quantization. In particular, the described techniques provide for a UE to indicate a capability to perform ML model quantization. For example, to account for varying capabilities of different UEs while improving ML model performance, the UE may transmit a message indicating a capability of the UE to support one or more quantization schemes for one or more ML models. A network entity may transmit a message configuring the UE with the quantization schemes or quantized ML models in accordance with the UE capability. The UE may perform one or more channel estimations, such as for beam management or channel state information (CSI) reporting, using an ML model with one or more quantization schemes.

### CROSS REFERENCE

The present Application is a 371 national phase filing of International PCT Application No. PCT/CN2023/089708 by REN et al., entitled “CAPABILITY-BASED MACHINE LEARNING MODEL QUANTIZATION,” filed Apr. 21, 2023, which is assigned to the assignee hereof, and which is expressly incorporated by reference in its entirety herein.

### FIELD OF TECHNOLOGY

The following relates to wireless communications, including capability-based machine learning (ML) model quantization.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support capability-based machine learning (ML) model quantization. In particular, the described techniques provide for a user equipment (UE) to indicate a capability to perform ML model quantization. For example, to account for varying capabilities of different UEs while improving ML model performance, the UE may transmit a message indicating a capability of the UE to support one or more quantization schemes for one or more ML models. A network entity may transmit a message configuring the UE with the quantization schemes or quantized ML models in accordance with the UE capability. The UE may perform one or more channel estimations, such as for beam management or channel state information (CSI) reporting, using an ML model with one or more quantization schemes.

A method for wireless communication at a UE is described. The method may include transmitting a first message indicating a capability of the UE to support one or more quantization schemes for a ML model, receiving a second message indicating whether the ML model is configured in accordance with the one or more quantization schemes based on the capability of the UE, and performing, using the ML model, one or more channel estimations in accordance with the second message.

An apparatus for wireless communication at a UE is described. The apparatus may include a processor, memory coupled with the processor, and instructions stored in the memory. The instructions may be executable by the processor to cause the apparatus to transmit a first message indicating a capability of the UE to support one or more quantization schemes for a ML model, receive a second message indicating whether the ML model is configured in accordance with the one or more quantization schemes based on the capability of the UE, and perform, using the ML model, one or more channel estimations in accordance with the second message.

Another apparatus for wireless communication at a UE is described. The apparatus may include means for transmitting a first message indicating a capability of the UE to support one or more quantization schemes for a ML model, means for receiving a second message indicating whether the ML model is configured in accordance with the one or more quantization schemes based on the capability of the UE, and means for performing, using the ML model, one or more channel estimations in accordance with the second message.

A non-transitory computer-readable medium storing code for wireless communication at a UE is described. The code may include instructions executable by a processor to transmit a first message indicating a capability of the UE to support one or more quantization schemes for a ML model, receive a second message indicating whether the ML model is configured in accordance with the one or more quantization schemes based on the capability of the UE, and perform, using the ML model, one or more channel estimations in accordance with the second message.

Some examples of the method, apparatuses, and non-transitory computer-readable medium described herein may further include operations, features, means, or instructions for receiving, via the second message, an indication of a configuration for the ML model based on the capability of the UE, the configuration indicating at least one quantization scheme from of the one or more quantization schemes supported by the UE for the ML model, where the one or more channel estimations may be performed in accordance with the configuration.

Some examples of the method, apparatuses, and non-transitory computer-readable medium described herein may further include operations, features, means, or instructions for receiving, via the second message, an indication of a configuration for the ML model based on the capability of the UE, the configuration indicating that the ML model may be configured independently of a quantization scheme, where the one or more channel estimations may be performed in accordance with the configuration.

Some examples of the method, apparatuses, and non-transitory computer-readable medium described herein may further include operations, features, means, or instructions for receiving, via the second message, an indication of a quantization configuration for the ML model based on the capability of the UE, the quantization configuration indicating a quantization scheme from of the one or more quantization schemes supported by the UE for the ML model, where the one or more channel estimations may be performed in accordance with the quantization scheme.

Some examples of the method, apparatuses, and non-transitory computer-readable medium described herein may further include operations, features, means, or instructions for transmitting an indication of an update to the ML model based on applying the quantization scheme with the ML model.

In some examples of the method, apparatuses, and non-transitory computer-readable medium described herein, the quantization configuration indicates a set of multiple quantization schemes and the method, apparatuses, and non-transitory computer-readable medium may include further operations, features, means, or instructions for selecting the quantization scheme from the set of multiple quantization schemes to apply to the ML model and transmitting an indication of the quantization scheme.

In some examples of the method, apparatuses, and non-transitory computer-readable medium described herein, the quantization configuration indicates quantization of a parameter for the ML model, respective quantization schemes for two or more parameters, or functions, or both, of the ML model, a quantization for reporting a feature, or any combination thereof.

Some examples of the method, apparatuses, and non-transitory computer-readable medium described herein may further include operations, features, means, or instructions for selecting a version of the ML model from a set of multiple versions of the ML model based on comparing respective performance metrics for the set of multiple versions of the ML model, where the respective performance metrics correspond to the one or more quantization schemes for the ML model and transmitting, via the first message, an indication of the respective performance metrics, the version of the ML model, or both, where the capability of the UE may be based on the indication, and where the second message indicates a configuration for the ML model based on the indication.

Some examples of the method, apparatuses, and non-transitory computer-readable medium described herein may further include operations, features, means, or instructions for receiving, via the second message, an indication of a set of multiple versions of the ML model and respective performance metrics for the set of multiple versions of the ML model, selecting a first version of the ML model from the set of multiple versions of the ML model based on comparing the respective performance metrics for the set of multiple versions of the ML model, where the respective performance metrics correspond to the one or more quantization schemes for the ML model, and transmitting a third message indicating the first version of the ML model, the respective performance metrics for the first version of the ML model, or both.

Some examples of the method, apparatuses, and non-transitory computer-readable medium described herein may further include operations, features, means, or instructions for receiving a fourth message indicating a set of multiple time-frequency resources corresponding to the one or more channel estimations based on the third message.

Some examples of the method, apparatuses, and non-transitory computer-readable medium described herein may further include operations, features, means, or instructions for selecting a second version of the ML model from the set of multiple versions of the ML model and transmitting a fifth message indicating respective performance metrics for the second version of the ML model, the second version of the ML model, or both.

Some examples of the method, apparatuses, and non-transitory computer-readable medium described herein may further include operations, features, means, or instructions for transmitting, via the first message, an indication of whether the ML model is to be quantized using the one or more quantization schemes, an indication of whether the ML model being quantized using the one or more quantization schemes may be supported by the UE, an indication of whether the ML model may be to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof, where the first message includes a capability message.

Some examples of the method, apparatuses, and non-transitory computer-readable medium described herein may further include operations, features, means, or instructions for transmitting, via the first message, a request for the ML model, the request including an indication of whether the ML model is to be quantized using the one or more quantization schemes, an indication of whether the ML model being quantized using the one or more quantization schemes may be supported by the UE, an indication of whether the ML model may be to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof.

In some examples of the method, apparatuses, and non-transitory computer-readable medium described herein, performing the one or more channel estimations may include operations, features, means, or instructions for obtaining, from an encoder of the UE, an output corresponding to one or more reference signals and applying the ML model to the output of the encoder in accordance with the second message.

In some examples of the method, apparatuses, and non-transitory computer-readable medium described herein, a granularity of the one or more quantization schemes may be based on whether the one or more quantization schemes correspond to respective ML models, respective layers, respective channels, respective parameter quantization, include a set of multiple different quantization schemes for the ML model, or any combination thereof.

In some examples of the method, apparatuses, and non-transitory computer-readable medium described herein, the one or more quantization schemes include a four bit quantization scheme, a five bit quantization scheme, an eight bit quantization scheme, a sixteen bit quantization scheme, or any combination thereof.

A method for wireless communication at a network entity is described. The method may include receiving a first message indicating a capability of a UE to support one or more quantization schemes, transmitting a second message indicating whether a ML model is configured in accordance with the one or more quantization schemes based on the capability of the UE, and receiving a report including information that is based on one or more channel estimations performed in accordance with the ML model.

An apparatus for wireless communication at a network entity is described. The apparatus may include a processor, memory coupled with the processor, and instructions stored in the memory. The instructions may be executable by the processor to cause the apparatus to receive a first message indicating a capability of a UE to support one or more quantization schemes, transmit a second message indicating whether a ML model is configured in accordance with the one or more quantization schemes based on the capability of the UE, and receive a report including information that is based on one or more channel estimations performed in accordance with the ML model.

Another apparatus for wireless communication at a network entity is described. The apparatus may include means for receiving a first message indicating a capability of a UE to support one or more quantization schemes, means for transmitting a second message indicating whether a ML model is configured in accordance with the one or more quantization schemes based on the capability of the UE, and means for receiving a report including information that is based on one or more channel estimations performed in accordance with the ML model.

A non-transitory computer-readable medium storing code for wireless communication at a network entity is described. The code may include instructions executable by a processor to receive a first message indicating a capability of a UE to support one or more quantization schemes, transmit a second message indicating whether a ML model is configured in accordance with the one or more quantization schemes based on the capability of the UE, and receive a report including information that is based on one or more channel estimations performed in accordance with the ML model.

Some examples of the method, apparatuses, and non-transitory computer-readable medium described herein may further include operations, features, means, or instructions for transmitting, via the second message, an indication of a configuration for the ML model based on the capability of the UE, the configuration indicating at least one quantization scheme from of the one or more quantization schemes supported by the UE for the ML model, where the one or more channel estimations may be based on the configuration.

Some examples of the method, apparatuses, and non-transitory computer-readable medium described herein may further include operations, features, means, or instructions for transmitting, via the second message, an indication of a configuration for the ML model based on the capability of the UE, the configuration indicating that the ML model may be configured independently of a quantization scheme, where the one or more channel estimations may be based on the configuration.

Some examples of the method, apparatuses, and non-transitory computer-readable medium described herein may further include operations, features, means, or instructions for transmitting, via the second message, an indication of a quantization configuration for the ML model based on the capability of the UE, the quantization configuration indicating a quantization scheme from of the one or more quantization schemes supported by the UE for the ML model, where the one or more channel estimations may be based on the quantization configuration.

Some examples of the method, apparatuses, and non-transitory computer-readable medium described herein may further include operations, features, means, or instructions for receiving an indication of an update to the ML model based on the quantization scheme being associated with the ML model.

Some examples of the method, apparatuses, and non-transitory computer-readable medium described herein may further include operations, features, means, or instructions for determining a set of multiple quantization schemes based on the capability of the UE, where the quantization configuration indicates the set of multiple quantization schemes and receiving an indication of the quantization scheme selected from the set of multiple quantization schemes.

In some examples of the method, apparatuses, and non-transitory computer-readable medium described herein, the quantization configuration indicates quantization of a parameter for the ML model, respective quantization schemes for two or more parameters, or functions, or both, of the ML model, a quantization for reporting a feature, or any combination thereof.

Some examples of the method, apparatuses, and non-transitory computer-readable medium described herein may further include operations, features, means, or instructions for receiving, via the first message, an indication of respective performance metrics for a set of multiple versions of the ML model, an indication of a version of the ML model, or both, where the version of the ML model may be from a set of multiple versions of the ML model based at least in part of the respective performance metrics, and where the second message indicates a configuration for the ML model based on the indication of the respective performance metrics, the indication of the version, or both.

Some examples of the method, apparatuses, and non-transitory computer-readable medium described herein may further include operations, features, means, or instructions for transmitting, via the second message, an indication of a set of multiple versions of the ML model and respective performance metrics for the set of multiple versions of the ML model and receiving a third message indicating a first version of the ML model selected from the set of multiple versions of the ML model based on the respective performance metrics, where the respective performance metrics correspond to the one or more quantization schemes for the ML model.

Some examples of the method, apparatuses, and non-transitory computer-readable medium described herein may further include operations, features, means, or instructions for transmitting a fourth message indicating a set of multiple time-frequency resources corresponding to the one or more channel estimations based on the third message.

Some examples of the method, apparatuses, and non-transitory computer-readable medium described herein may further include operations, features, means, or instructions for receiving a fifth message indicating a second version of the ML model from the set of multiple versions of the ML model, respective performance metrics for the second version of the ML model, or both.

Some examples of the method, apparatuses, and non-transitory computer-readable medium described herein may further include operations, features, means, or instructions for receiving, via the first message, an indication of whether the ML model is to be quantized using the one or more quantization schemes, an indication of whether the ML model being quantized using the one or more quantization schemes may be supported by the UE, an indication of whether the ML model may be to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof, where the first message includes a capability message.

Some examples of the method, apparatuses, and non-transitory computer-readable medium described herein may further include operations, features, means, or instructions for receiving, via the first message, a request for the ML model, the request including an indication of whether the ML model is to be quantized using the one or more quantization schemes, an indication of whether the ML model being quantized using the one or more quantization schemes may be supported by the UE, an indication of whether the ML model may be to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof.

In some examples of the method, apparatuses, and non-transitory computer-readable medium described herein, a granularity of the one or more quantization schemes may be based on whether the one or more quantization schemes correspond to respective ML models, respective layers, respective channels, respective parameter quantization, include a set of multiple different quantization schemes for the ML model, or any combination thereof.

In some examples of the method, apparatuses, and non-transitory computer-readable medium described herein, the one or more quantization schemes include a four bit quantization scheme, a five bit quantization scheme, an eight bit quantization scheme, a sixteen bit quantization scheme, or any combination thereof.

### BRIEF DESCRIPTION OF THE DRAWINGS

FIG. 1 shows an example of a wireless communications system that supports capability-based machine learning (ML) model quantization in accordance with one or more aspects of the present disclosure.

FIG. 2 shows an example of a wireless communications system that supports capability-based ML model quantization in accordance with one or more aspects of the present disclosure.

FIGS. 3A and 3B show examples of ML model diagrams that support capability-based ML model quantization in accordance with one or more aspects of the present disclosure.

FIG. 4 shows an example of a process flow that supports capability-based ML model quantization in accordance with one or more aspects of the present disclosure.

FIG. 5 shows an example of a process flow that supports capability-based ML model quantization in accordance with one or more aspects of the present disclosure.

FIG. 6 shows an example of a process flow that supports capability-based ML model quantization in accordance with one or more aspects of the present disclosure.

FIG. 7 shows an example of a process flow that supports capability-based ML model quantization in accordance with one or more aspects of the present disclosure.

FIGS. 8 and 9 show block diagrams of devices that support capability-based ML model quantization in accordance with one or more aspects of the present disclosure.

FIG. 10 shows a block diagram of a communications manager that supports capability-based ML model quantization in accordance with one or more aspects of the present disclosure.

FIG. 11 shows a diagram of a system including a device that supports capability-based ML model quantization in accordance with one or more aspects of the present disclosure.

FIGS. 12 and 13 show block diagrams of devices that support capability-based ML model quantization in accordance with one or more aspects of the present disclosure.

FIG. 14 shows a block diagram of a communications manager that supports capability-based ML model quantization in accordance with one or more aspects of the present disclosure.

FIG. 15 shows a diagram of a system including a device that supports capability-based ML model quantization in accordance with one or more aspects of the present disclosure.

FIGS. 16 through 21 show flowcharts illustrating methods that support capability-based ML model quantization in accordance with one or more aspects of the present disclosure.

### DETAILED DESCRIPTION

In some wireless communications systems, one or more wireless devices may use a machine learning (ML) model to perform estimations related to communications with a network entity (e.g., beam management, channel state information (CSI) channel estimations, or the like). In some cases, the ML model may utilize one or more convolutional layers, which may include weights, biases, and an activation function. To increase accuracy of outputs of a ML model, the ML model may have a relatively high degree of complexity (e.g., many convolutional layers, a relatively complex activation function, or the like). A high degree of complexity may result in increased processing time and processing power. Thus, to reduce processing time and processing power (e.g., for power-limited devices, for functions and operations with relatively low accuracy, or the like), quantization of various parameters may be used with the ML model (e.g., weight quantization, quantization of inputs and/or outputs associated with respective layers, or the like). However, the quantization may negatively impact ML model performance (e.g., resulting in relatively reduced accuracy) due to relatively less precise weights, biases, and activation functions, and may be less suitable for functions and operations that rely on relatively high accuracy. Some devices (e.g., a relatively high-power UE) may support relatively more complex ML models (mixed quantization, different levels of quantization), while other UEs may not support quantization or may support ML model quantization with relatively low complexity (e.g., a UE may support only limited quantization schemes). As such, techniques to determine whether ML model quantization can be used in a wireless communications system may be desirable.

Accordingly, the techniques described herein may allow for a UE to indicate a capability to perform ML model quantization. For example, to account for varying capabilities of UEs within a system, and while improving ML model performance, a UE may transmit a message indicating a capability of the UE to support one or more quantization schemes (e.g., a sixteen bit quantization scheme (INT16), an eight bit quantization scheme (INT8), a four bit quantization scheme (INT4), or the like) for one or more ML models. A network entity may transmit a message configuring the UE with one or more quantization schemes or a quantized ML models in accordance with the UE capability (e.g., as indicated by the UE capability). The UE may perform one or more channel estimations, such as for beam management or CSI reporting, using an ML model with the one or more quantization schemes. For example, the network entity may indicate that the UE may use multiple quantization schemes for the ML model, and the UE may select a quantization scheme which satisfies a threshold performance metric of the ML model. In some other examples, the network entity may indicate that the UE use the ML model without applying a quantization scheme to the ML model (e.g., in cases where the UE does not support a particular quantization scheme, or the quantization scheme(s) supported by the UE are unable to satisfy some performance threshold, among other examples).

Aspects of the disclosure are initially described in the context of wireless communications systems. Aspects of the disclosure are further illustrated by and described with reference to ML model diagrams and process flow diagrams. Aspects of the disclosure are further illustrated by and described with reference to apparatus diagrams, system diagrams, and flowcharts that relate to capability-based ML model quantization.

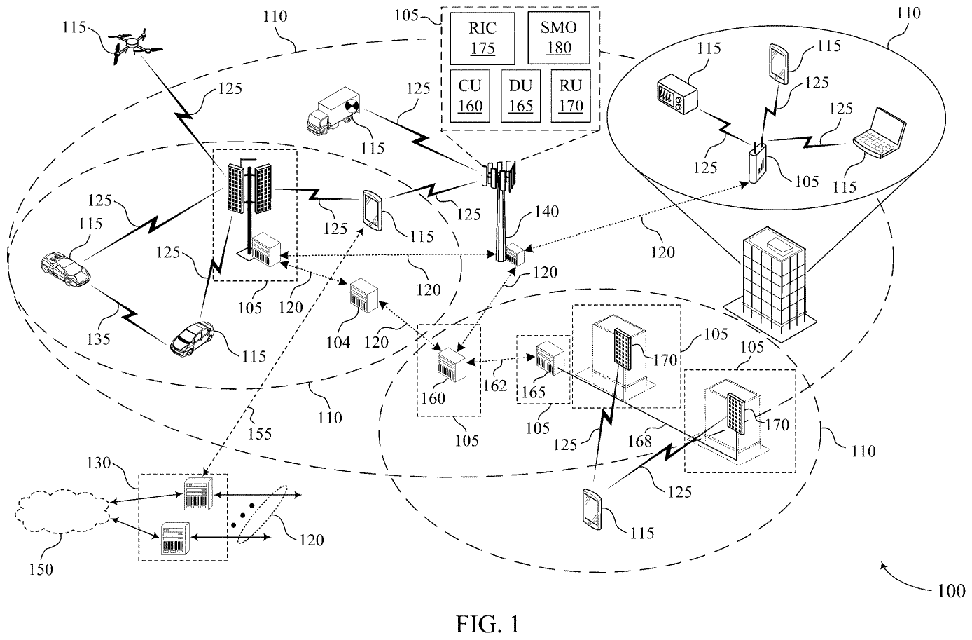

FIG. 1 shows an example of a wireless communications system 100 that supports capability-based ML model quantization in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support capability-based ML model quantization as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Wireless communications system 100 may support artificial intelligence (AI) and ML techniques to enhance over-the-air communications or other information communications via an interface between a UE 115 and a network entity 105. For example, AI and ML techniques may be used in wireless communications system 100 to support enhancements to beam management such as enhancements in beam prediction, spatial domain beamforming for overhead and latency reduction, increased beam selection accuracy including accuracy enhancements for different scenarios including those associated with heavy non-line of sight (NLOS) beamforming conditions, among other examples. The wireless communications system 100 may accordingly support operation of one or more machine learning servers. In some examples, a machine learning server may be or be otherwise located within (e.g., as component of) a network entity 105. Alternatively, the machine learning server may be a standalone device which may be in communication with one or more UEs 115 and the network entity 105. In some aspects, AI and/or ML functionality may be implemented in one or more UEs or one or more network entities 105, or any combination thereof, in the wireless communications system 100.

In some implementations of AI and ML, network entities 105 and interface procedures may support data management and model management for different AI and ML models that may be implemented. For example, a network entity 105 may support multi-vendor interoperability between different AI and ML functions, such as data collection, model training, and model inference. Additionally, or alternatively, a network entity 105 may support integration and collaboration of additional communications techniques such as orbital angular momentum (OAM), core network functions, new generation networks, and air interface implementations with AI and ML.

Wireless communications system 100 may support capability signaling for indicating whether a UE 115 supports ML model quantization techniques, including indications of some quantization schemes supported by the UE 115. Wireless communications system 100 may support techniques that enable a UE 115 to indicate a capability to perform ML model quantization. For example, to account for varying capabilities of the UEs 115 in wireless communications system 100 while improving ML model performance, the UE 115 may transmit a message indicating a capability of the UE 115 to support one or more quantization schemes (e.g., INT16, INT8, INT4, or the like) for one or more ML models. A network entity 105 may transmit a message configuring the UE 115 with one or more quantization schemes or quantized ML models based on the indicated UE capability. The UE 115 may perform one or more channel estimations, such as for beam management or CSI reporting, using an ML model with one or more quantization schemes. For example, the network entity 105 may indicate that the UE 115 may use multiple quantization schemes for the ML model, and the UE 115 may select a quantization scheme which satisfies a threshold performance metric of the ML model. Otherwise, the network entity 105 may indicate for the UE 115 to use the ML model without applying a quantization scheme to the ML model.

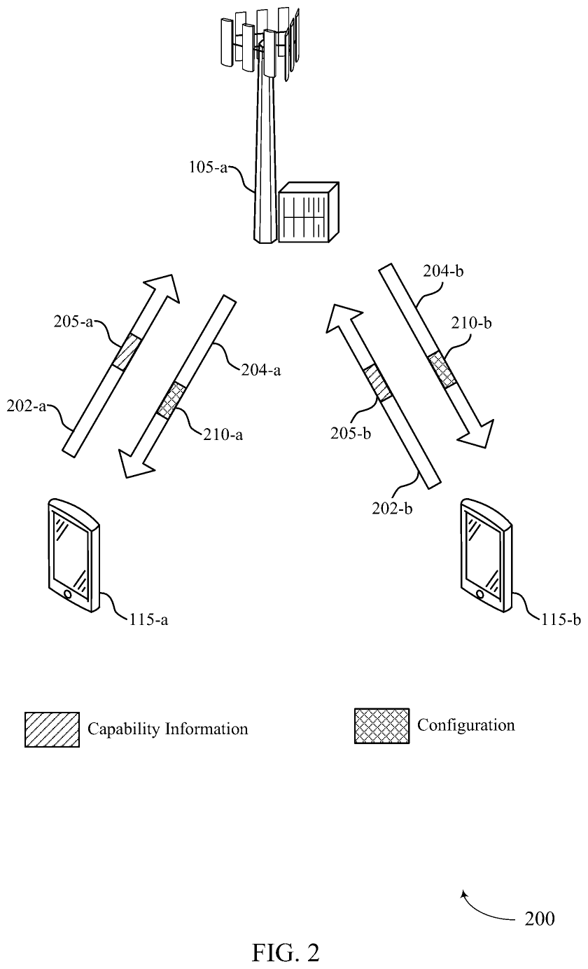

FIG. 2 shows an example of a wireless communications system 200 that supports capability-based ML model quantization in accordance with one or more aspects of the present disclosure. The wireless communications system 200 may implement aspects of or may be implemented by aspects of the wireless communications system 100. For example, the wireless communications system 200 may include one or more UEs 115 (e.g., a UE 115-a and a UE 115-b) and a network entity 105 (e.g., a network entity 105-a), which may be examples of the corresponding devices described with reference to FIG. 1.

The UE 115-a and the UE 115-b may communicate with the network entity 105-a using an uplink communication link 202-a and an uplink communication link 202-b, respectively. The uplink communication link 202-a and the uplink communication link 202-b may be examples of communications links 125 as described with reference to FIG. 1. The UE 115-a may transmit uplink signals (e.g., uplink transmissions), such as uplink control signals or uplink data signals, to the network entity 105-a using the uplink communication link 202-a. Similarly, the UE 115-b may transmit uplink signals (e.g., uplink transmissions), such as uplink control signals or uplink data signals, to the network entity 105-a using the uplink communication link 202-b. The network entity 105-a may transmit downlink signals (e.g., downlink transmissions), such as downlink control signals or downlink data signals, to the UE 115-a and the UE 115-b using a downlink communication link 204-a and a downlink communication link 204-b, respectively, where the downlink communication link 204-a and the downlink communication link 204-b may be examples of communication links 125 as described with reference to FIG. 1.

In some examples, the UE 115-a, the UE 115-b, or both may be examples of power-limited, or low-power, UEs 115. For example, one or both of the UE 115-a and the UE 115-b may be low-tier UEs 115, which may transmit signals with a relatively lower transmission power when compared with a high-tier, or high-power, UE 115. Additionally, or alternatively, one or both of the UE 115-a and the UE 115-b may process signals with a relatively lower complexity than the high-tier UE 115, which may result in reduced power consumption at the UE 115-a and the UE 115-b. Further, in some cases, the UE 115-a, the UE 115-b, or both may operate with memory or computation conditions that may prevent the use of complex ML models. In some other examples, the UE 115-a, the UE 115-b, or both may be examples of high-power UEs 115, which may not operate using a reduced transmit power, reduced power consumption, or both.

In the wireless communications system 200, a UE 115 (e.g., UE 115-a, UE 115-b) may use an ML model to perform estimations for communicating with the network entity 105-a (e.g., beam management, CSI channel estimations, error vector magnitude (EVM) measurements, or the like). In some cases, the ML model may include multiple layers (e.g., convolutional layers), where at least one layer may include a set of parameters and an activation function. In some cases, the parameters may be referred to as weights and biases. Some ML models may have a relatively high degree of complexity (e.g., and, accordingly, increased accuracy), and may thus result in increased processing time and processing power to obtain outputs.

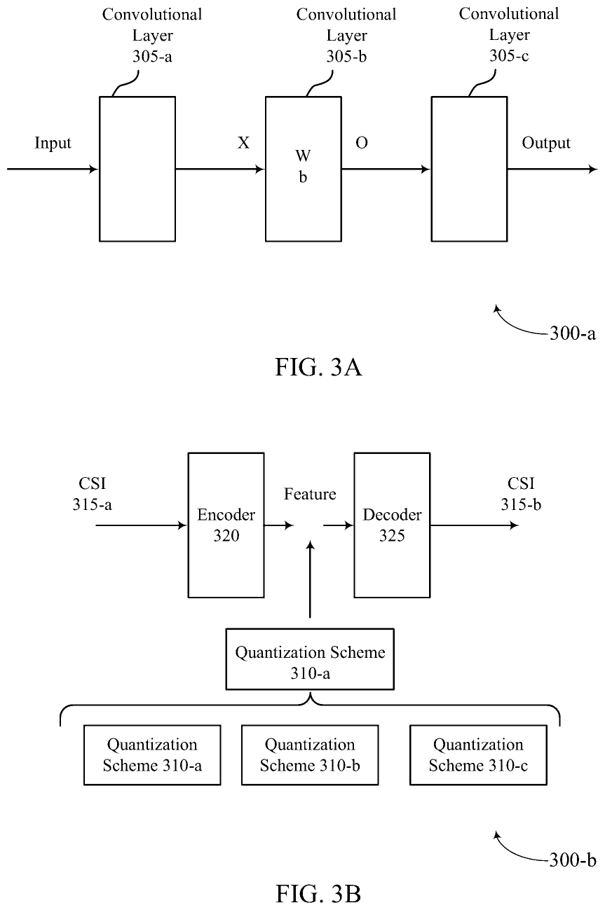

To reduce complexity of an ML model, UEs 115 may use quantization with the ML model (e.g., INT16 or INT8) with a relatively reduced precision of the weights, biases, and activation functions. The quantization of the ML model may increase throughput and reduce the processing burden for the ML model as a result of the reduced complexity, which may be advantageous for power-limited devices (e.g., the UE 115-a, the UE 115-b) or for functions and operations that do not rely on high accuracy. However, quantization of aspects of an ML model may negatively impact ML model performance (e.g., resulting in reduced accuracy) due to relatively less precise weights, biases, and activation functions, and thus may be less suitable for functions and operations that are associated with (e.g., rely on) relatively high accuracy. Some devices (e.g., the UE 115-a or the UE 115-b, or both, which may be high-power UEs 115), may support relatively more complex ML models with mixed quantization, different levels of quantization, and the like, which is described in further detail with respect to FIGS. 3A and 3B. The application of quantization schemes to different convolutional layers of the ML model, to model weights, to model features, or any combination thereof, may be referred to as mixed quantization. For example, a portion of the ML model may be quantized with an INT8 quantization scheme, and one or more other portions of the ML model may be quantized with an INT16 quantization scheme. Some other devices (e.g., the UE 115-a, the UE 115-b, or both) may not support quantization or may support ML model quantization with relatively low complexity. In some cases, mixed quantization may additionally or alternatively refer to different ML quantization schemes supported by respective UEs 115, for example, for federated learning processes. As such, techniques to determine whether ML model quantization can be used in the wireless communications system 200 may be desirable.

Accordingly, the UE 115-a, the UE 115-b, or both may indicate a capability of the UE 115-a, the UE 115-b, or both to support one or more quantization schemes to a network entity 105-a. For example, the UE 115-a may transmit a message including capability information 205-a to the network entity 105-a. The capability information 205-a may indicate a capability of the UE 115-a to support one or more quantization schemes (e.g., an INT4 quantization scheme, an INT8 quantization scheme, or the like) for an ML model. The relatively high-power UE 115-b may transmit a message including capability information 205-b to the network entity 105-a. In some examples, the capability information 205-b may indicate a capability of the UE 115-b to support one or more quantization schemes (e.g., an INT4 quantization scheme, an INT8 quantization scheme, an INT16 quantization scheme, or the like) for an ML model. For example, if the UE 115-a, the UE 115-b, or both are examples of low-power UEs 115, the UE 115-a, the UE 115-b, or both may request a relatively less complex quantization scheme, such as an INT4 quantization scheme or an INT8 quantization scheme, for the ML model. In some other examples, if the UE 115-a or the UE 115-b, or both are examples of high-power UEs 115, the UE 115-a, the UE 115-b, or both may request a relatively more complex quantization scheme, such as an INT16 quantization scheme or no quantization scheme, for the ML model. In some examples, the capability information 205-a and the capability information 205-b may include a request from the UE 115-a and the UE 115-b, respectively, for a specific quantization scheme supported by the UE 115-a and the UE 115-b.

In some cases, the UE 115-a, the UE 115-b, or both may transmit the capability information 205-a and the capability information 205-b, respectively, in control signaling to the network entity 105-a via an uplink communication link 202-a and an uplink communication link 202-b. The UE 115-a, the UE 115-b, or both may transmit the capability information 205-a, the capability information 205-b, or both using bits in a capability reporting messages, in a new capability message dedicated to the ML model quantization scheme information, or in any other control signaling to the network entity 105-a. The capability information 205-a, the capability information 205-b, or both may include one or more capability information elements (IEs), where an IE is information which may be included within control signaling (e.g., RRC signaling) and/or data transmission.

The capability information 205-a, the capability information 205-b, or both may include respective fields and/or a set of bits that indicate the ML quantization capabilities supported by a UE 115. For instance, the capability information 205-a may include one bit to indicate whether the UE 115-a uses or supports ML model quantization, one bit to indicate the quantization for one function or use case, one bit to indicate a supported quantization format (e.g., a set of quantization formats, where a set={FP32, FP16, INT8, INT16}, a set={INT8}, or others), one bit to indicate whether mixed quantization is supported, one or more bits to indicate the granularity of the quantization, or any combination thereof. The capability information 205-b may include similar fields and/or bits.

The function or use case indicated by the capability information 205 may include a beam management ML model, channel estimation ML model, or the like. The granularity of the quantization indicated by the capability information 205 may include an indication of whether per model-based quantization is supported, where each ML model of a set of ML models may be enabled with different quantization schemes separately (e.g., an ML model for CSI estimation is quantized with an INT16 quantization scheme, an ML model for beam management is quantized with an INT8 quantization scheme, and the like). The granularity of the quantization may include whether an ML model weight and ML model activation function may be separately enabled for the quantization (e.g., for an ML model, a weight is quantized with an INT8 quantization scheme and an activation function may be quantized with an INT16 quantization scheme or may not be quantized). In some aspects, the granularity of the quantization may include whether per layer-based quantization is supported (e.g., for an ML model with three convolutional layers, a first layer is quantized using an INT8 quantization scheme, a second convolutional layer is quantized using an INT16 quantization scheme, and a third layer is quantized using the INT8 or the INT16 quantization scheme). Additionally, or alternatively, the granularity of the quantization may include whether per channel-based quantization is supported (e.g., for one layer with 64 channels in one ML model, some channels may be quantized using an INT8 quantization scheme, and some channels may be quantized using an INT16 quantization scheme).

As an illustrative example, an IE that indicates ML quantization capabilities supported by the UE 115 (e.g., UEMLQuantCap) may have a format similar to:

```
UEMLQuantCap-IEs:::= SEQUENCE {
  QuantizedModelForBM,
  QuantFormat,
  MixedQuant,
  QuantGranularity,
},
```

where, QuantizedModelForBM (e.g., one bit) may indicate whether model quantization may be used or may indicate quantization for a particular function (e.g., beam management, or BM, in this example), QuantFormat (e.g., 1 bit) may indicate a supported quantization format, MixedQuant (e.g., 1 bit) may indicate whether mixed quantization is supported, and QuantGranularity (e.g., N bits, where N may be an integer greater than 0) may indicate the granularity of the quantization.

Additionally, an IE that indicates quantization granularity capabilities of the UE 115 (e.g., QuantGranularityCap) may have a format similar to:

```
QuantGranularityCap-IEs:::= SEQUENCE {
  QuantizedPerModel,
  QuantizedPara,
  QuantizedAct,
  QuantizedPerLayer,
  QuantizedPerChannel,
  }
```

where respective fields of the IE may provide indications of various quantization granularity capabilities of the UE 115. For example, the field QuantizedPerModel may indicate whether per-ML model quantization is supported, the field QuantizedPara may indicate whether respective parameters of an ML model (e.g., model weight, model bias) may be quantized with some granularity or some quantization scheme, the field QuantizedAct may indicate whether some functions of the ML model (e.g., model activation) may be quantized with some granularity or some quantization scheme, the field QuantizedPerLayer may indicate whether per layer-based quantization is supported, and the field QuantizedPerChannel may indicate whether per-channel-based quantization is supported.

The network entity 105-a may accordingly transmit control signaling including a configuration 210-a and a configuration 210-b to the UE 115-a and the UE 115-b, respectively, via the downlink communication link 204-a and the downlink communication link 204-b. For example, in response to receiving the capability information 205-a, the network entity 105-a may configure the UE 115-a with one or more ML models with one or more quantization schemes (e.g., as indicated or requested by the UE 115-a in the capability information 205-a). The network entity 105-a may additionally, or alternatively, configure the UE 115-a with one or more quantization schemes for an ML model which is already configured at the UE 115-a (e.g., as indicated or requested by the UE 115-a in the capability information 205-a). The network entity 105-a may configure the UE 115-b with one or more quantized ML models and/or one or more quantization schemes according to the capability information 205-b.

In some examples, the network entity 105-a may configure the UE 115-a and the UE 115-b with multiple ML model quantization schemes. In such examples, the UE 115-a and the UE 115-b may each select one or more of the quantization schemes to apply to the ML model. The UE 115-a, the UE 115-b, or both may indicate the selected scheme to the network entity 105-a. The UE 115-a and/or the UE 115-b may additionally, or alternatively, determine to switch to a different quantization scheme for the ML model, and the UE 115-a and/or the UE 115-b may indicate the new selected scheme to the network entity 105-a. For example, the UE 115-a, the UE 115-b, or both may apply a single quantization scheme to the input, parameters, and each layer of the ML model in accordance with accuracy thresholds for the output of the ML model and processing and/or power capabilities of the UE 115-a, the UE 115-b, or both, which is described in further detail with respect to FIG. 3A. In some other examples, the UE 115-a, the UE 115-b, or both may apply multiple (e.g., different) quantization schemes to the input, parameters, and layers of the ML model in accordance with the accuracy thresholds and processing and/or power capabilities of the UE 115-a, the UE 115-b, or both, which is described in further detail with respect to FIG. 3A.

In some examples, the network entity 105-a may indicate for the UE 115-a and/or the UE 115-b to use an ML model without applying a quantization scheme (e.g., independent of a quantization scheme). For example, if the UE 115-a indicates support for the INT8 or INT4 quantization scheme, the network entity 105-a may determine that the UE 115-a may maintain a level of performance without using a quantization scheme. The network entity 105-a may accordingly indicate for the UE 115-a to use the ML model without applying a quantization scheme. For example, the network entity 105-a may transmit a configuration None (e.g., indicating that quantization is not configured) or transmit a rejection of the ML model requested by the UE 115-a, indicating that there is not an available quantization scheme for the UE 115-a to use.

The UE 115-a and the UE 115-b may perform one or more channel estimations (e.g., for beam management, CSI reporting, or the like) using the ML model. That is, the UE 115-a, the UE 115-b, or both may apply one or more quantization schemes to the ML model, and may use the quantized ML model to perform the one or more channel estimations, which is described in further detail with respect to FIGS. 3A and 3B. The UE 115-a and the UE 115-b may accordingly perform the channel estimations with reduced power consumption and/or relatively higher accuracy (e.g., depending on the one or more applied quantization scheme).

For example, the UE 115-a, the UE 115-b, or both may use the ML model for ML-based CSI compression. The UE 115-a, the UE 115-b, or both may implement the ML model at an encoder to compress raw CSI information, while the network entity 105-a may implement an ML model at a decoder to decompress the compressed CSI information. In some cases, the UE 115-a, the UE 115-b, or both may quantize the encoder ML model with a relatively less complex quantization scheme (e.g., an INT8 quantization scheme), which may reduce the complexity for UE deployment of the ML model. In some cases, if the performance of the ML model (e.g., accuracy, power consumption, or other performance metrics) depends on the quantization of the output feature at the encoder, the network entity 105-a may indicate for the UE 115-a, the UE 115-b, or both to apply a relatively more complex quantization scheme, such as an INT16 quantization scheme, to the output feature. For example, the raw CSI information may be compressed by the encoder, and the output may be further quantized at the UE 115-a, the UE 115-b, or both with an INT16 quantization scheme.

In some other cases, if the performance of the ML model depends less on the quantization method, or does not depend on the quantization method, the network entity 105-a may indicate several quantization schemes as options for the UE 115-a, the UE 115-b, or both to select from (e.g., {INT16,INT8,INT4}). The UE 115-a, the UE 115-b, or both may consider the uplink time-frequency resource utilization, and may use a relatively less complex quantization scheme for feature quantization, which may reduce uplink time-frequency resource utilization. The UE 115-a, the UE 115-b, or both may report the quantization scheme to the network entity 105-a. If the UE 115-a, the UE 115-b, or both are low-power UEs (e.g., if the UE capability is relatively low), the UE 115-a, the UE 115-b, or both may use a default quantization scheme, which may be an INT8 quantization scheme. Thus, the network entity 105-a may not indicate a quantization scheme other than the default quantization scheme, or the UE 115-a, the UE 115-b, or both may use the default quantization scheme regardless of the quantization scheme indicated by the network entity 105-a. The UE 115-a, the UE 115-b, or both may use the default quantization scheme for channel estimation, such as in the physical layer.

FIGS. 3A and 3B show examples of an ML model diagram 300-a and an ML model diagram 300-b, respectively, that support capability-based ML model quantization in accordance with one or more aspects of the present disclosure. The ML model diagram 300-a and the ML model diagram 300-b may implement aspects of or may be implemented by aspects of the wireless communications system 100 and/or the wireless communications system 200. For example, the ML model diagram 300-a and the ML model diagram 300-b may be implemented by a UE 115 and a network entity 105, which may be examples of the corresponding devices described with reference to FIGS. 1 and 2.

In some wireless communications systems, a UE 115 may use a ML model that implements a neural network (NN) algorithm, which may be referred to as an NN model, to perform one or more channel estimations. For example, the UE 115 may use an NN model to predict a set of parameters for transmitting or receiving a communication beam as part of a beam management procedure, to improve accuracy of a CSI feedback procedure, and the like. The NN model may include a set of parameters and a model structure. The set of parameters may, for example, include weights of the NN model, among other configuration parameters for the NN model, and may vary depending on a location of the UE 115 or a configuration of the NN model. The model structure may be identified by a model identification (ID) which may be unique to the model structure. The model ID may additionally indicate a default parameter set and a neural network function (NNF).

The NNF may be defined as a function (e.g., Y=F(X)) and may be identified by a NNF ID. For example, the NNF may be a standardized NNF and may be identified by a standardized NNF ID, which may be common across multiple vendors. In some other examples, the NNF may be non-standardized and may be identified by a non-standardized, or private, NNF ID, which may not be common across vendors. A standardized NNF may include an input X and an output Y that are common across the multiple vendors, while a non-standardized NNF may include an input X and an output Y that are not common across the multiple vendors.

In some cases, the NNF may additionally include one or more IEs. For example, the NNF may include mandatory IEs, which may be used by each vendor to standardize communications between vendors (e.g., for inter-vendor interworking) and optional IEs, which may be used by vendors (e.g., the vendors may flexibly implement the optional IEs). Each of the NNF ID, IEs, and NN models may, for example, be defined by one or more of a vendor, an operator, or another entity.

To reduce complexity and thus power consumption at the UE 115, the UE 115 may apply a quantization scheme 310 to the NN model. For example, the UE 115 may apply a quantization scheme 310 to a baseline ML model (e.g., a floating point (FP) 32 model or a FP64 model) to generate a quantized model (e.g., an INT16 model, an INT8 model, a mixed INT16+8 model). The quantized model may be relatively less complex than the baseline ML model, and thus may reduce power consumption and latency caused by using the model. However, the reduced complexity of the model may result in relatively reduced accuracy. Thus, it may be advantageous for the UE 115 to apply a quantization scheme 310 if, for example, the UE 115 does not support the baseline ML model or to reduce latency (e.g., for performing channel estimations in the physical layer). However, it may be advantageous for the UE 115 to refrain from applying a quantization scheme 310 if, for example, the UE 115 does support the baseline ML model and a latency condition is met (e.g., for applications in an upper layer with relatively low frequency, such as scheduling or scenario detection).

In some examples, one or more UEs and network entities may generate the baseline ML model (e.g., one quantized model) that results in relatively high performance metrics. Based on capabilities (e.g., hardware capabilities) of the UEs 115, deployment requests, or the like, the UEs 115 may quantize the weights, biases, and/or activation function into bit widths corresponding to quantization schemes 310. In other words, one baseline ML model may be mapped to different versions of the quantized model (e.g., an INT8 ML model, an INT16 ML model, or others). Different versions of the baseline ML model may have different complexity and performance metrics. For each different version, the ML model structure may be the same, and the weights, biases, and activation function format may be different.

The UE 115 may apply a quantization scheme 310 to approximate a NN model that uses floating-point quantization by using a NN model that uses quantization schemes with a relatively low bit width. The UE 115 may apply the quantization scheme 310 to the weights and/or biases of the NN model, the activation function of the NN model, or both. That is, the UE 115 may perform weight quantization on the set of parameters to convert the parameters from floating-point to bit values (e.g., parameters W and b, which may correspond to a weight and a bias, respectively). The UE 115 may perform activation quantization on the model features or activation function to convert the activation function from floating-point to bit values (e.g., input X and output O). In some aspects, the UE 115 may apply the quantization scheme 310 at one or more convolutional layers 305 (e.g., a convolutional layer 305-a, a convolutional layer 305-b, and a convolutional layer 305-c).

For example, the UE 115 may generate the quantized model by applying the quantization scheme 310 to the baseline ML model. That is, the UE 115 may map the baseline ML model to one or more of the different versions of the quantized model. As the UE 115 applies the quantization scheme 310 to the weights and features of the model (e.g., the parameters, input, and output), the structure of the model may be unchanged while the weight and activation format may change due to the quantization. Thus, the UE 115 may apply the quantization scheme 310 to the baseline ML model to generate one of multiple different versions of the quantized model, which may be relatively more or less complex and may have varying performance (e.g., accuracy).

The UE 115 may apply the quantization scheme 310 to the ML model in accordance with a granularity that aligns with the capability and performance conditions for the UE 115. In some examples, the UE 115 may apply different versions of the quantization scheme 310 to each convolutional layer 305. In some other examples, the UE 115 may apply a first quantization scheme 310 to the model weights and a second quantization scheme 310 to the model features. The UE 115 applying different versions of the quantization scheme 310 to convolutional layers 305, to model weights and model features, or both may be referred to as mixed quantization. Such mixed quantization techniques may allow the UE 115 to reduce complexity and/or improve accuracy of the ML model at a more granular level (e.g., more effectively).

For example, the UE 115 may use the quantized ML model to perform a beam prediction procedure (e.g., beam prediction in the time and/or spatial domain). The baseline ML model may have a relatively higher accuracy of the beam prediction procedure (e.g., 99% accuracy), while the quantized model may have a relatively lower accuracy of the beam prediction procedure (e.g., 70% accuracy). The UE 115 may accordingly analyze a sensitivity related to the accuracy of the model parameters, features, and convolutional layers 305. That is, the UE 115 may determine relatively less sensitive parts of the ML model which may be quantized without reducing accuracy (e.g., below a threshold). The UE 115 may additionally determine relatively more sensitive parts of the ML model which may not be quantized without reducing accuracy (e.g., below a threshold). Accordingly, the UE 115 may apply a relatively more complex quantization scheme 310 (e.g., with a larger bit width) to relatively more sensitive parts of the ML model and a relatively less complex quantization scheme 310 (e.g., with a smaller bit width) to relatively less sensitive parts of the ML model. Applying a relatively more complex quantization scheme 310 may preserve additional information for the ML model, which may improve accuracy of the ML model.

In some examples, if the UE 115 determines the model features to be more sensitive and the model parameters to be less sensitive, the UE 115 may apply an INT16 quantization scheme to the model inputs and outputs and an INT4 quantization scheme to the model parameters. Additionally, or alternatively, the UE 115 may apply different quantization schemes 310 to each convolutional layer 305. That is, the UE 115 may apply an INT8 quantization scheme to the convolutional layer 305-a and an INT16 quantization scheme to the convolutional layer 305-c.

Some wireless communications systems may use a federated learning model in which multiple devices (e.g., multiple UEs 115, multiple network entities, or both) may implement various ML models. In such systems, the multiple UEs 115 and/or the multiple network entities 105 may support different ML models and/or different levels of complexity (e.g., different quantization schemes 310). The multiple UEs 115 and/or the multiple network entities 105 may additionally, or alternatively, have different performance conditions or deployment constraints. Accordingly, the multiple UEs 115 and/or the multiple network entities 105 may apply different quantization schemes 310 to generate different quantized ML models (e.g., and may update a network entity 105 accordingly). Thus, such systems may include mixed quantization as a result of different quantization schemes 310 being applied at each of the multiple UEs 115 (e.g., as opposed to different quantization schemes 310 being applied at each convolutional layer 305 by a single device, and the like).

In some examples, one or both of the UE 115 and the network entity 105 may train the ML model. That is, the UE 115 and the network entity 105 may jointly train the ML model at one or both of the UE 115 and the network entity 105. Additionally, or alternatively, the UE 115 and the network entity 105 may separately train the ML model. That is, the UE 115 and the network entity 105 may each train part of the ML model. For example, in the case of an ML model used for CSI feedback, the UE 115 may train a part of the ML model for CSI encoding (e.g., at an encoder 320) and the network entity 105 may train a part of the ML model for CSI decoding (e.g., at a decoder 325). In systems which include a federated learning model, the UE 115 may train the part of the ML model for the encoder 320 to achieve a desired performance (e.g., accuracy) and complexity (e.g., with a high compression and low bit quantization scheme 310).

For example, the UE 115 may input a CSI 315-a into the encoder 320, and the encoder 320 may compress the CSI 315-a and output a feature. The network entity 105 may indicate a quantization scheme 310-a to the UE 115 for the UE 115 to apply to the encoder 320. For example, if the CSI feedback procedure is sensitive to the quantization, the network entity 105 may indicate for the UE 115 to apply a quantization scheme 310-a with a relatively higher bit width (e.g., INT16). If the CSI feedback procedure is relatively less sensitive to the quantization, the network entity 105 may indicate multiple quantization schemes 310 (e.g., a quantization scheme 310-a, a quantization scheme 310-b, and a quantization scheme 310-c), and the UE 115 may select the quantization schemes 310-a with a relatively lower bit width (e.g., INT4) to apply to the encoder 320. In such examples, the UE 115 may indicate the selected quantization scheme 310-a to the network entity 105. In some examples, the UE 115 may support one quantization scheme 310-a (e.g., INT8), and the network entity 105 may not indicate a quantization scheme 310 for the UE 115 to use. The quantized output of the encoder 320 (e.g., the feature) may be the input of the decoder 325.

The network entity 105 may receive the feature and input the feature into the decoder 325. The network entity 105 may use the quantization scheme 310-a to train the part of the ML model for the decoder 325 (e.g., to dequantize the feature). The network entity 105 may accordingly generate a restructured (e.g., decoded and dequantized) CSI 315-b.

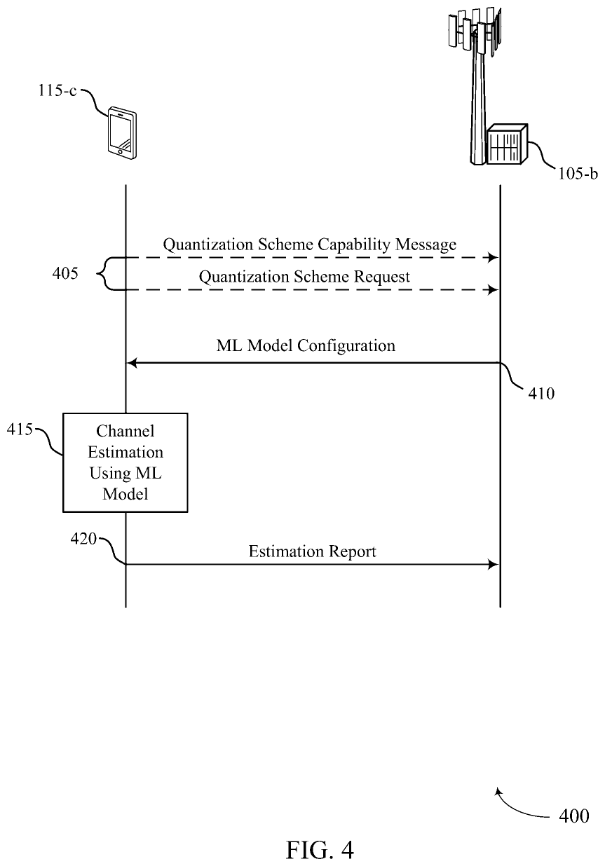

FIG. 4 shows an example of a process flow 400 that supports capability-based ML model quantization in accordance with one or more aspects of the present disclosure. The process flow 400 may implement aspects of or may be implemented by aspects of the wireless communications system 100, the wireless communications system 200, the ML model diagram 300-a, or the ML model diagram 300-b. For example, the process flow 400 may include a UE 115 (e.g., a UE 115-c) and a network entity 105 (e.g., a network entity 105-b), which may be examples of the corresponding devices described with reference to FIG. 1.

In the following description of the process flow 400, the operations between the network entity 105-b and the UE 115-c may be transmitted in a different order than the example order shown. Some operations may also be omitted from the process flow 400, and other operations may be added to the process flow 400.

At 405, the UE 115-c may transmit a first message to the network entity 105-b indicating a capability of the UE 115-c to support one or more quantization schemes for one or more ML models. For example, the first message may include one or more bits for capability information indicating one or more quantization schemes which the UE 115-c may apply to an ML model. The capability information may include one or more of an indication of whether the ML model is to be quantized using the one or more quantization schemes, an indication of whether the ML model being quantized using the one or more quantization schemes is supported by the UE 115-c, an indication of whether the ML model is to use the one or more quantization schemes for a function (for beam management, CSI reporting, or the like), an indication of support of a set of quantization schemes of the one or more quantization schemes, an indication of whether the UE 115-c supports one or more different quantization schemes for the ML model, and an indication of a granularity of the one or more quantization schemes.

In some examples, the first message may include a request for a specific quantization scheme. For example, the request may include one or more of an indication of whether the ML model is to be quantized using the one or more quantization schemes, an indication of whether the ML model being quantized using the one or more quantization schemes is supported by the UE 115-c, an indication of whether the ML model is to use the one or more quantization schemes for a function (for beam management, CSI reporting, or the like), an indication of support of a set of quantization schemes of the one or more quantization schemes, an indication of whether the UE 115-c supports one or more different quantization schemes for the ML model, or an indication of the granularity of the one or more quantization schemes, or any combination thereof. The first message may be transmitted by the UE 115-c, for example, via an uplink control message (e.g., uplink control information (UCI)), or may be one or more bits included in some other control signaling (e.g., with other capability information associated with the UE 115-c).

In some examples, the one or more quantization schemes may include one or more of an INT4 quantization scheme, a five bit (INT5) quantization scheme, an INT8 quantization scheme, and an INT16 quantization scheme. The indication of the granularity of the one or more quantization schemes may include whether the one or more quantization schemes correspond to respective ML models, respective layers, respective channels, or respective parameter quantization. The indication of the granularity of the one or more quantization schemes may additionally, or alternatively, include whether the one or more quantization schemes include multiple different quantization schemes for the ML model.

At 410, the network entity 105-b may transmit a configuration for an ML model to the UE 115-c. For example, the network entity 105-b may configure the UE 115-c with a quantized ML model for the UE 115-c to use for one or more channel estimations. The network entity 105-b may configure the quantized ML model in accordance with the first message. For example, the quantized ML model may be quantized in accordance with one of the one or more quantization schemes indicated by the first message. The network entity 105-b may configure the quantized ML model in accordance with the request for the specific quantization scheme.

In some examples, the network entity 105-b may configure the UE 115-c with an ML model independent of the one or more quantization schemes. For example, the network entity 105-b may determine that the UE 115-c may not support a quantization scheme which maintains an acceptable performance (e.g., the UE 115-c may support quantization schemes which do not meet an accuracy threshold). The network entity 105-b may accordingly indicate for the UE 115-c to not apply a quantized ML model (e.g., and may therefore reject the request for the specific quantization scheme).

At 415, the UE 115-c may perform one or more channel estimations using the ML model in accordance with the quantization scheme. For example, the UE 115-c may perform a beam management procedure using the ML model. In some examples, the UE 115-c may perform a CSI reporting procedure using the ML model. For example, the UE 115-c may receive a reference signal and process the reference signal via an encoder. The UE 115-c may apply the ML model to an output of the encoder and process the resulting encoded CSI via a decoder to obtain a restructured CSI.

At 420, the UE 115-c may transmit, to the network entity 105-b, an estimation report for the one or more channel estimations. For example, the estimation report may include information regarding the beam management procedure or the CSI reporting procedure.

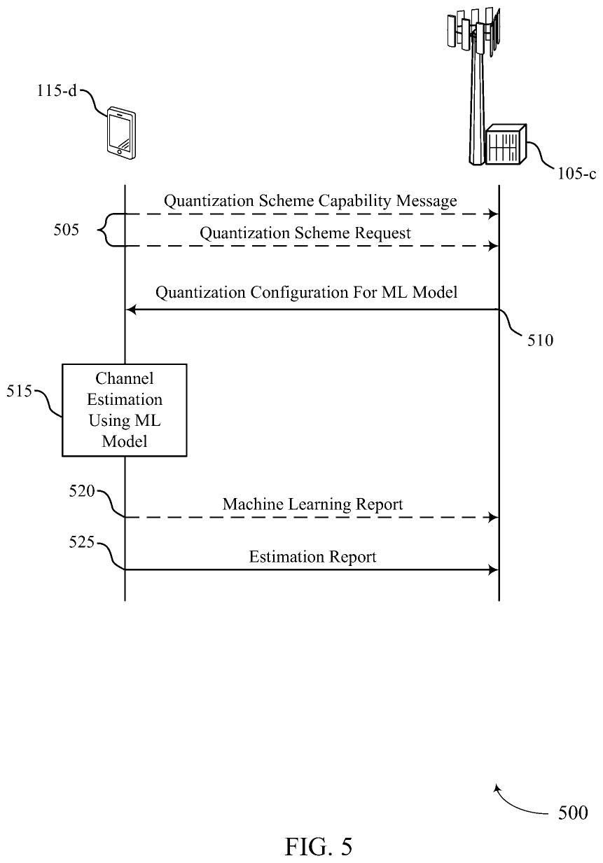

FIG. 5 shows an example of a process flow 500 that supports capability-based ML model quantization in accordance with one or more aspects of the present disclosure. The process flow 500 may implement aspects of or may be implemented by aspects of the wireless communications system 100, the wireless communications system 200, the ML model diagram 300-a, or the ML model diagram 300-b. For example, the process flow 500 may include a UE 115 (e.g., a UE 115-d) and a network entity 105 (e.g., a network entity 105-c), which may be examples of the corresponding devices as described with reference to FIG. 1.

In the following description of the process flow 500, the operations between the network entity 105-c and the UE 115-d may be transmitted in a different order than the example order shown. Some operations may also be omitted from the process flow 500, and other operations may be added to the process flow 500.

At 505, the UE 115-d may transmit a first message to the network entity 105-c indicating a capability of the UE 115-c to support one or more quantization schemes for an ML model configured at the UE 115-c. The first message may include capability information or a request for a specific quantization scheme (e.g., as similarly described with reference to FIG. 4).

At 510, the network entity 105-c may transmit a configuration for one or more quantization schemes for the ML model to the UE 115-d. For example, the network entity 105-b may configure the UE 115-c with one or more quantization schemes for the ML model for the UE 115-c to use for one or more channel estimations. The network entity 105-b may configure the one or more quantization schemes in accordance with the first message. For example, the one or more quantization schemes may be some or all of the one or more quantization schemes indicated by the first message. The network entity 105-b may configure the one or more quantization schemes in accordance with the request for the specific quantization scheme. The configuration may include one or more of a parameter for the ML model (e.g., only a parameter, such as W and/or b, may be quantized), respective quantization schemes for two or more parameters and/or functions of the ML model (e.g., parameter with INT8, activation with INT16), or a quantization for reporting a feature (e.g., indicate a reported features with INT16 quantization). As an illustrative example, if one of the one or more quantization scheme configurations includes a first quantization scheme for parameter quantization and a second quantization scheme for activation quantization, the configuration may have a format similar to:
{parameter quantization, activation quantization}

If one of the one or more quantization scheme configurations includes multiple potential options for model quantization, the configuration may have a format similar to:
method={INT8/INT16/INT4}

In some examples (e.g., if the network entity 105-c configures the UE 115-d with multiple potential options for quantization schemes), the UE 115-d may select one of the multiple potential quantization schemes and apply the quantization scheme to the ML model.

At 515, the UE 115-d may perform one or more channel estimations using the ML model, and based on the configuration for the one or more quantization schemes of the ML model. For example, the UE 115-d may perform a beam management procedure using the ML model. In some examples, the UE 115-d may perform a CSI reporting procedure using the ML model. For example, the UE 115-d may receive a reference signal and process the reference signal via an encoder. The UE 115-d may apply the ML model to an output of the encoder and process the resulting encoded CSI via a decoder to obtain a restructured CSI.

In some examples, at 520, the UE 115-d may transmit an update to the ML model to the network entity 105-c. For example, the UE 115-d may report a model or feature update caused by applying the quantization scheme. In some examples (e.g., if the UE 115-d selects one of multiple quantization schemes configured by the network entity 105-c), the UE 115-d may transmit an indication of the selected quantization scheme to the network entity 105-c. The update and indication may, for example, be used for de-quantization (e.g., for recovery of information).

At 525, the UE 115-d may transmit an estimation report to the network entity 105-b for the one or more channel estimations as described with reference to FIG. 4.

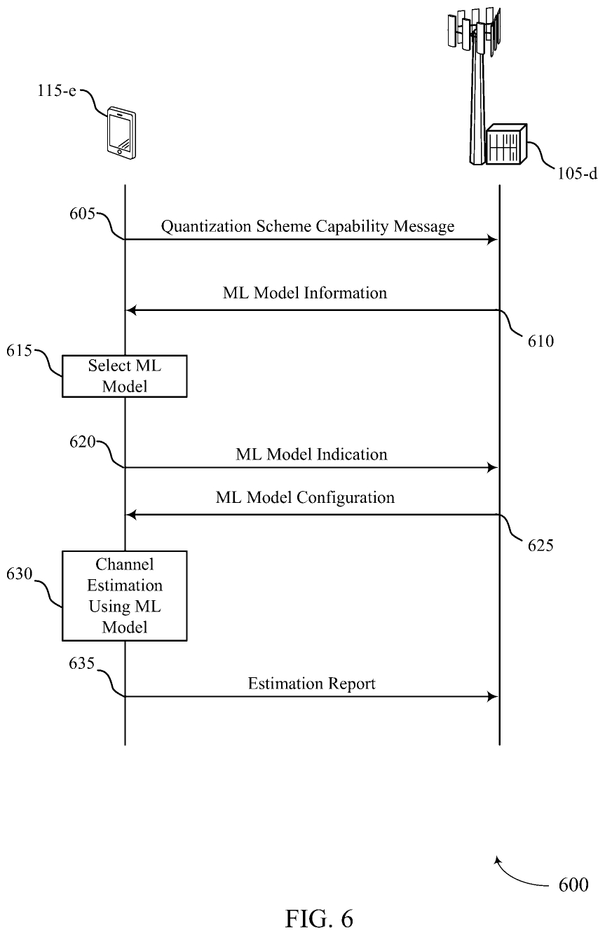

FIG. 6 shows an example of a process flow 600 that supports capability-based ML model quantization in accordance with one or more aspects of the present disclosure. The process flow 600 may implement aspects of or may be implemented by aspects of the wireless communications system 100, the wireless communications system 200, the ML model diagram 300-a, or the ML model diagram 300-b. For example, the process flow 600 may include a UE 115 (e.g., a UE 115-e) and a network entity 105 (e.g., a network entity 105-d), which may be examples of the corresponding devices as described with reference to FIG. 1.

In the following description of the process flow 600, the operations between the network entity 105-d and the UE 115-e may be transmitted in a different order than the example order shown. Some operations may also be omitted from the process flow 600, and other operations may be added to the process flow 600.

At 605, the UE 115-e may transmit a first message to the network entity 105-d indicating a capability of the UE 115-e to support one or more quantization schemes for one or more ML models or NNs, as described with reference to FIG. 4.

At 610, the network entity 105-d may transmit information regarding the one or more quantization schemes for the one or more ML models (e.g., or NNs) to the UE 115-e in accordance with the first message. For example, the UE 115-e may indicate, via the first message, that the UE 115-e may support multiple versions of the ML models, and the network entity 105-d may transmit information regarding the multiple versions of the ML models. The information may include one or more of indications of the multiple versions of the ML models (e.g., model IDs), quantization schemes for the ML models, and performance metrics (e.g., NN performance metrics, a reference accuracy for beam prediction, or the like) of the quantized ML models. In some cases, the network entity 105-d may transmit signaling indicating the potential versions of the ML model, where the configuration includes a model version, quantization information, and a reference accuracy for beam prediction (e.g., for three potential versions of the ML model, the configuration may include (model ID1, INT8, 90%), (model ID2, INT16, 95%), and (model ID3, INT8-16 mixed, 94%)). In such examples, the indication of the information related to the ML models may have the format: (model version, quantization information, performance metrics/information (such as reference accuracy in beam prediction, in one example)).

At 615, the UE 115-e may select one of the multiple versions of the ML models for the UE 115-e to use in one or more channel estimations. For example, the UE may select one or more model IDs (e.g., the model ID1, the model ID2, the model ID3, or any combination thereof) for deployment, the UE 115-e may select one of the multiple versions of the ML models by comparing the performance metrics and selecting one of the multiple versions of the quantized ML models which has a desired performance (e.g., an accuracy or complexity which meets a threshold).

At 620, the UE 115-e may transmit an indication of the selected version of the ML model to the network entity 105-d. For example, the UE 115-e may transmit an indication of one or more model IDs (e.g., the model ID1, the model ID2, the model ID3, or any combination thereof) of the selected versions of the ML model. In some examples, the UE 115-e may transmit an indication of the performance metrics of the multiple versions of the ML models. The indication may be an example of capability information, as described with reference to FIG. 4.

At 625, the network entity 105-d may transmit a configuration for the selected version of the ML model to the UE 115-e, including the ML model structure and corresponding model parameters (e.g., weights and biases). The network entity 105-d may configure the quantized ML model in accordance with the selected version of the ML model as described with reference to FIG. 4.

At 630, the UE 115-e may perform one or more channel estimations using the quantized ML model as described with reference to FIG. 4.

At 635, the UE 115-e may transmit an estimation report for the one or more channel estimations to the network entity 105-d as described with reference to FIG. 4.

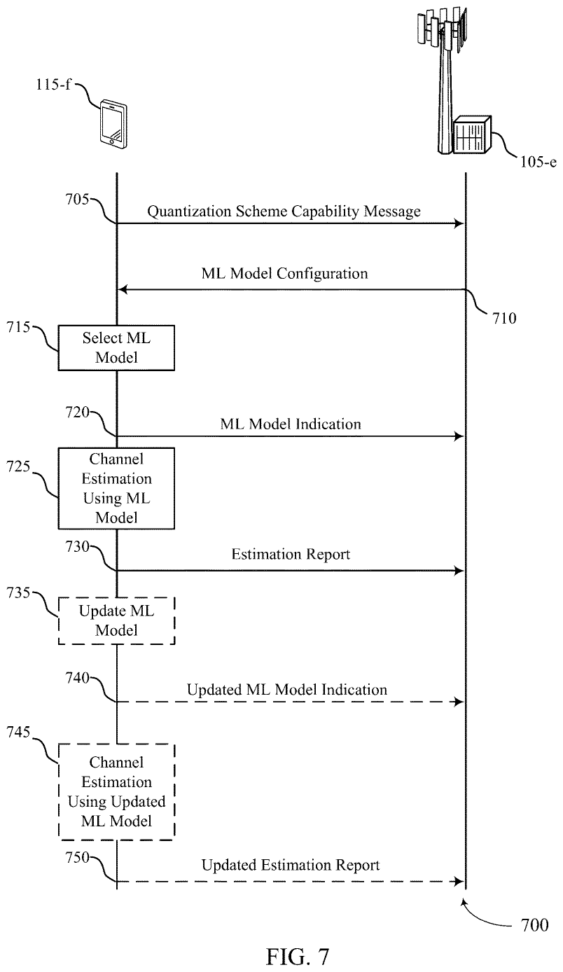

FIG. 7 shows an example of a process flow 700 that supports capability-based ML model quantization in accordance with one or more aspects of the present disclosure. The process flow 700 may implement aspects of or may be implemented by aspects of the wireless communications system 100, the wireless communications system 200, the ML model diagram 300-a, or the ML model diagram 300-b. For example, the process flow 700 may include a UE 115 (e.g., a UE 115-f) and a network entity 105 (e.g., a network entity 105-e), which may be examples of the corresponding devices as described with reference to FIG. 1.

In the following description of the process flow 700, the operations between the network entity 105-e and the UE 115-f may be transmitted in a different order than the example order shown. Some operations may also be omitted from the process flow 700, and other operations may be added to the process flow 700.

At 705, the UE 115-f may transmit a first message to the network entity 105-e indicating a capability of the UE 115-f to support one or more quantization schemes for one or more ML models or NNs, as described with reference to FIG. 4.

At 710, the network entity 105-e may transmit a configuration message to the UE 115-f which may configure the UE 115-f with multiple quantized ML models. For example, the network entity 105-e may configure the UE 115-f with multiple quantized ML models for the UE 115-f to use for one or more channel estimations. The network entity 105-e may configure the quantized ML models in accordance with the first message. For example, the quantized ML models may be quantized in accordance with one or more of the one or more quantization schemes indicated by the first message. The configuration message may include, for example, one or more of model IDs, quantization schemes, and performance metrics (e.g., a predicted model accuracy) for each of the multiple quantized ML models. In some cases, the configuration message may include a model version, a quantized model, and a reference accuracy for beam prediction for each of the quantized ML models (e.g., for three potential quantized ML models, the configuration may include (model ID1, quantized model, 90%), (model ID2, quantized model, 95%), and (model ID3, quantized model, 94%)). In such examples, the indication of the information related to the ML model versions may have the format: (model version, quantization information, performance metrics/information (such as reference accuracy in beam prediction, in one example)).

At 715, the UE 115-f may select one of the multiple quantized ML models. For example, the UE 115-f may select one or more quantized ML models which meet a condition (e.g., a threshold value) for performance metrics, power, accuracy, hardware implementation, or any combination thereof. For example, the UE 115-f may select one or more of the quantized models with the model ID1, the model ID2, or the model ID3.

At 720, the UE 115-f may transmit an indication of the selected quantized ML model to the network entity 105-e. The indication of the selected quantized ML model may include, for example, a model ID (e.g., an index of the model ID) and one or more performance metrics of the selected quantized ML model. The one or more performance metrics may include, for example, an actual accuracy in beam prediction. For example, if the UE 115-f selects the quantized ML model with model ID1, the UE 115-f may transmit an indication including the model ID1 and indicating the actual accuracy for the beam prediction as 90%. In such examples, the indication may have the format: (model ID (index), actual performance metrics/information (actual accuracy for beam prediction, in one example)).

The network entity 105-e may indicate one or more time-frequency resources for one or more channel estimations (e.g., performance monitoring) depending on the performance metrics.

At 725, the UE 115-f may perform the one or more channel estimations using the selected quantized ML model as described with reference to FIG. 4. For example, the UE 115-f may perform the one or more channel estimations using the indicated time-frequency resources.

At 730, the UE 115-f may transmit an estimation report for the one or more channel estimations to the network entity 105-e as described with reference to FIG. 4.

In some examples, at 735, the UE 115-f may update the quantized ML model (e.g., the UE 115-f may perform ML model switching). For example, the UE 115-f may switch to a different one of the one or more quantized ML models. The UE 115-f may update the quantized ML model to select a different quantized ML model which meets a condition (e.g., a threshold value) for performance metrics, power constraints, accuracy constraints, hardware constraints, or some combination thereof.

In some examples, at 740, the UE 115-f may transmit an indication of the updated quantized ML model to the network entity 105-e. The indication of the updated quantized ML model may include, for example, a model ID and one or more performance metrics (e.g., an accuracy of the quantized model) of the updated quantized ML model. The network entity may indicate one or more new time-frequency resources for one or more additional channel estimations (e.g., performance monitoring) depending on the performance metrics. The indication of the updated quantized ML model may have a format similar to the indication of the selected quantized model, as described with reference to step 720.

In some examples, at 745, the UE 115-f may perform one or more additional channel estimations using the updated quantized ML model as described with reference to FIG. 4. For example, the UE 115-f may perform the one or more additional channel estimations using the new time-frequency resources.

In some examples, at 750, the UE 115-f may transmit an estimation report to the network entity 105-e for the one or more additional channel estimations as described with reference to FIG. 4.

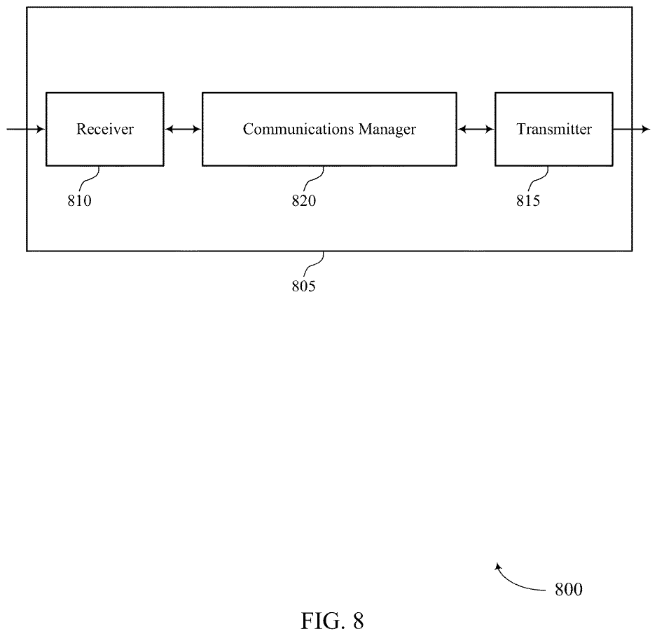

FIG. 8 shows a block diagram 800 of a device 805 that supports capability-based ML model quantization in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to capability-based ML model quantization). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to capability-based ML model quantization). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of capability-based ML model quantization as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 is capable of, configured to, or operable to support a means for transmitting a first message indicating a capability of the UE to support one or more quantization schemes for a ML model. The communications manager 820 is capable of, configured to, or operable to support a means for receiving a second message indicating whether the ML model is configured in accordance with the one or more quantization schemes based on the capability of the UE. The communications manager 820 is capable of, configured to, or operable to support a means for performing, using the ML model, one or more channel estimations in accordance with the second message.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a UE to indicate a capability of the UE to perform ML model quantization, which may result in reduced processing and reduced power consumption.

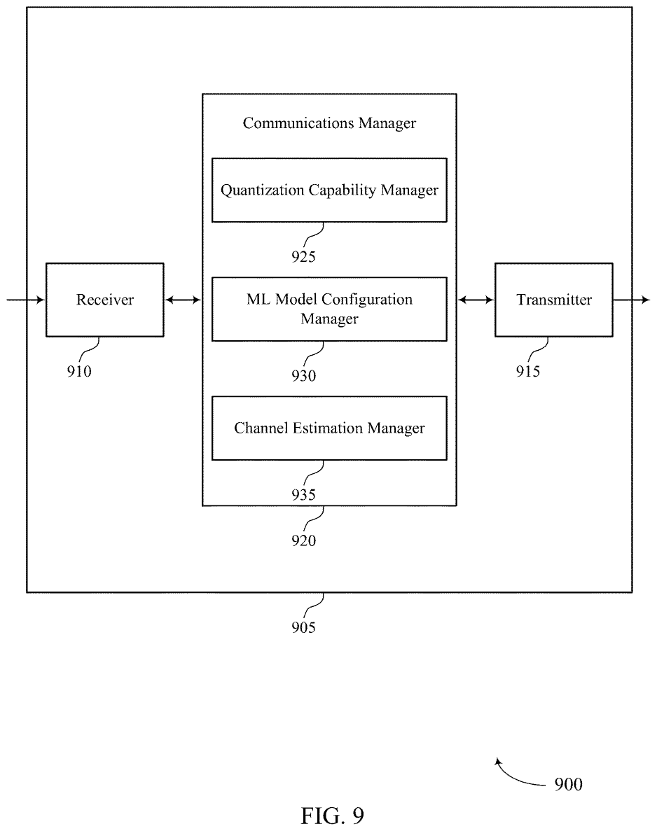

FIG. 9 shows a block diagram 900 of a device 905 that supports capability-based ML model quantization in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to capability-based ML model quantization). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to capability-based ML model quantization). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of capability-based ML model quantization as described herein. For example, the communications manager 920 may include a quantization capability manager 925, an ML model configuration manager 930, a channel estimation manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The quantization capability manager 925 is capable of, configured to, or operable to support a means for transmitting a first message indicating a capability of the UE to support one or more quantization schemes for a ML model. The ML model configuration manager 930 is capable of, configured to, or operable to support a means for receiving a second message indicating whether the ML model is configured in accordance with the one or more quantization schemes based on the capability of the UE. The channel estimation manager 935 is capable of, configured to, or operable to support a means for performing, using the ML model, one or more channel estimations in accordance with the second message.

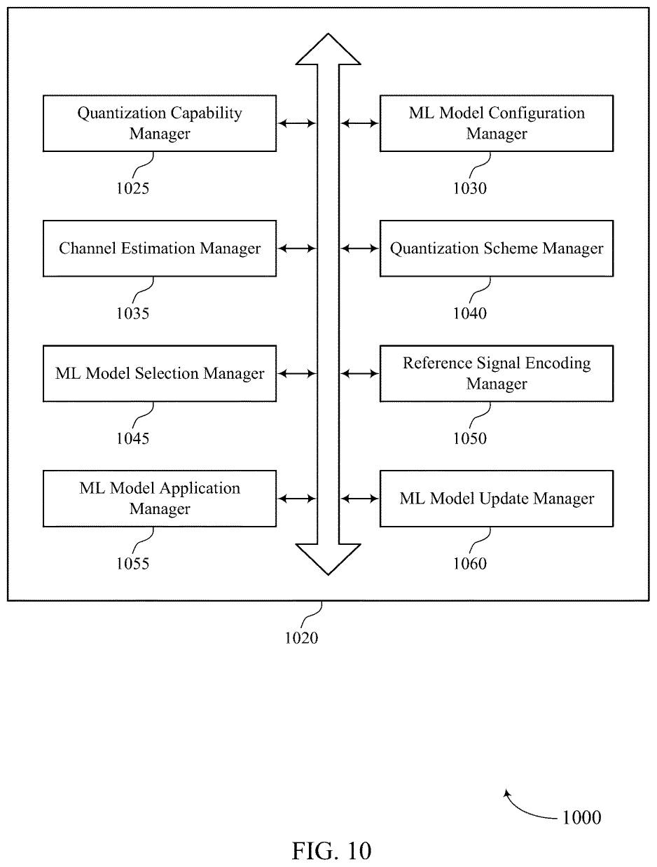

FIG. 10 shows a block diagram 1000 of a communications manager 1020 that supports capability-based ML model quantization in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of capability-based ML model quantization as described herein. For example, the communications manager 1020 may include a quantization capability manager 1025, an ML model configuration manager 1030, a channel estimation manager 1035, a quantization scheme manager 1040, an ML model selection manager 1045, a reference signal encoding manager 1050, an ML model application manager 1055, an ML model update manager 1060, or any combination thereof. Each of these components may communicate, directly or indirectly, with one another (e.g., via one or more buses).

The communications manager 1020 may support wireless communication at a UE in accordance with examples as disclosed herein. The quantization capability manager 1025 is capable of, configured to, or operable to support a means for transmitting a first message indicating a capability of the UE to support one or more quantization schemes for a ML model. The ML model configuration manager 1030 is capable of, configured to, or operable to support a means for receiving a second message indicating whether the ML model is configured in accordance with the one or more quantization schemes based on the capability of the UE. The channel estimation manager 1035 is capable of, configured to, or operable to support a means for performing, using the ML model, one or more channel estimations in accordance with the second message.

In some examples, the ML model configuration manager 1030 is capable of, configured to, or operable to support a means for receiving, via the second message, an indication of a configuration for the ML model based on the capability of the UE, the configuration indicating at least one quantization scheme from of the one or more quantization schemes supported by the UE for the ML model, where the one or more channel estimations are performed in accordance with the configuration.

In some examples, the ML model configuration manager 1030 is capable of, configured to, or operable to support a means for receiving, via the second message, an indication of a configuration for the ML model based on the capability of the UE, the configuration indicating that the ML model is configured independently of a quantization scheme, where the one or more channel estimations are performed in accordance with the configuration.

In some examples, the quantization scheme manager 1040 is capable of, configured to, or operable to support a means for receiving, via the second message, an indication of a quantization configuration for the ML model based on the capability of the UE, the quantization configuration indicating a quantization scheme from of the one or more quantization schemes supported by the UE for the ML model, where the one or more channel estimations are performed in accordance with the quantization scheme.

In some examples, the ML model update manager 1060 is capable of, configured to, or operable to support a means for transmitting an indication of an update to the ML model based on applying the quantization scheme with the ML model.

In some examples, the quantization configuration indicates a set of multiple quantization schemes, and the quantization scheme manager 1040 is capable of, configured to, or operable to support a means for selecting the quantization scheme from the set of multiple quantization schemes to apply to the ML model. In some examples, the quantization configuration indicates a set of multiple quantization schemes, and the quantization scheme manager 1040 is capable of, configured to, or operable to support a means for transmitting an indication of the quantization scheme.

In some examples, the quantization configuration indicates quantization of a parameter for the ML model, respective quantization schemes for two or more parameters, or functions, or both, of the ML model, a quantization for reporting a feature, or any combination thereof.

In some examples, the ML model selection manager 1045 is capable of, configured to, or operable to support a means for selecting a version of the ML model from a set of multiple versions of the ML model based on comparing respective performance metrics for the set of multiple versions of the ML model, where the respective performance metrics correspond to the one or more quantization schemes for the ML model. In some examples, the quantization capability manager 1025 is capable of, configured to, or operable to support a means for transmitting, via the first message, an indication of the respective performance metrics, the version of the ML model, or both, where the capability of the UE is based on the indication, and where the second message indicates a configuration for the ML model based on the indication.

In some examples, the ML model configuration manager 1030 is capable of, configured to, or operable to support a means for receiving, via the second message, an indication of a set of multiple versions of the ML model and respective performance metrics for the set of multiple versions of the ML model. In some examples, the ML model selection manager 1045 is capable of, configured to, or operable to support a means for selecting a first version of the ML model from the set of multiple versions of the ML model based on comparing the respective performance metrics for the set of multiple versions of the ML model, where the respective performance metrics correspond to the one or more quantization schemes for the ML model. In some examples, the ML model selection manager 1045 is capable of, configured to, or operable to support a means for transmitting a third message indicating the first version of the ML model, the respective performance metrics for the first version of the ML model, or both.

In some examples, the channel estimation manager 1035 is capable of, configured to, or operable to support a means for receiving a fourth message indicating a set of multiple time-frequency resources corresponding to the one or more channel estimations based on the third message.

In some examples, the ML model selection manager 1045 is capable of, configured to, or operable to support a means for selecting a second version of the ML model from the set of multiple versions of the ML model. In some examples, the ML model selection manager 1045 is capable of, configured to, or operable to support a means for transmitting a fifth message indicating respective performance metrics for the second version of the ML model, the second version of the ML model, or both.

In some examples, the quantization capability manager 1025 is capable of, configured to, or operable to support a means for transmitting, via the first message, an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof, where the first message includes a capability message.

In some examples, the quantization capability manager 1025 is capable of, configured to, or operable to support a means for transmitting, via the first message, a request for the ML model, the request including an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof.

In some examples, to support performing the one or more channel estimations, the reference signal encoding manager 1050 is capable of, configured to, or operable to support a means for obtaining, from an encoder of the UE, an output corresponding to one or more reference signals. In some examples, to support performing the one or more channel estimations, the ML model application manager 1055 is capable of, configured to, or operable to support a means for applying the ML model to the output of the encoder in accordance with the second message.

In some examples, a granularity of the one or more quantization schemes is based on whether the one or more quantization schemes correspond to respective ML models, respective layers, respective channels, respective parameter quantization, include a set of multiple different quantization schemes for the ML model, or any combination thereof.

In some examples, the one or more quantization schemes include a four bit quantization scheme, a five bit quantization scheme, an eight bit quantization scheme, a sixteen bit quantization scheme, or any combination thereof.

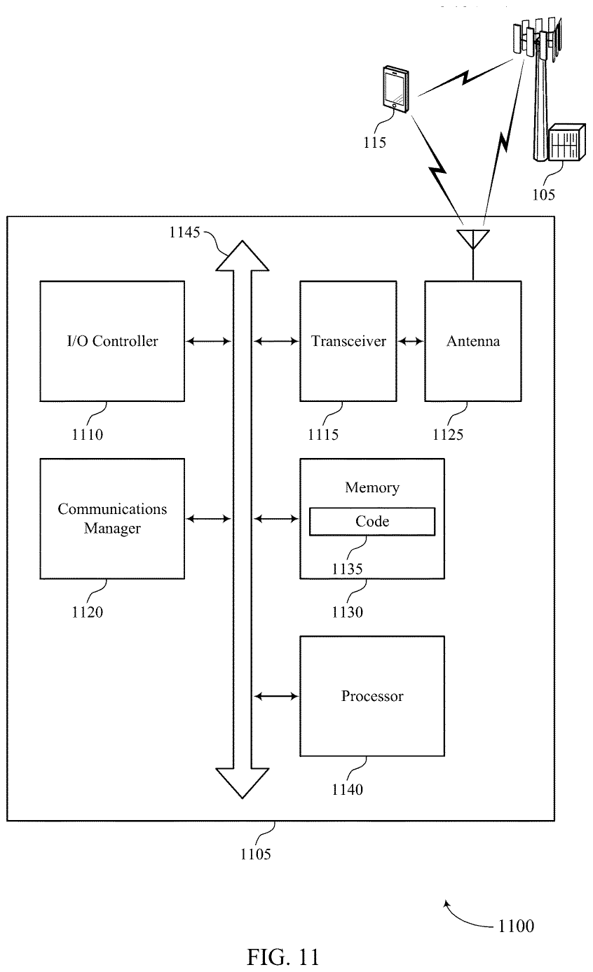

FIG. 11 shows a diagram of a system 1100 including a device 1105 that supports capability-based ML model quantization in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting capability-based ML model quantization). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 is capable of, configured to, or operable to support a means for transmitting a first message indicating a capability of the UE to support one or more quantization schemes for a ML model. The communications manager 1120 is capable of, configured to, or operable to support a means for receiving a second message indicating whether the ML model is configured in accordance with the one or more quantization schemes based on the capability of the UE. The communications manager 1120 is capable of, configured to, or operable to support a means for performing, using the ML model, one or more channel estimations in accordance with the second message.

By including or configuring the communications manager 1120 in accordance with examples as described herein, the device 1105 may support techniques for a UE to indicate a capability of the UE to perform ML model quantization, which may result in improved communication reliability, reduced latency, improved user experience related to reduced processing, reduced power consumption, improved coordination between devices, and longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of capability-based ML model quantization as described herein, or the processor 1140 and the memory 1130 may be otherwise configured to perform or support such operations.

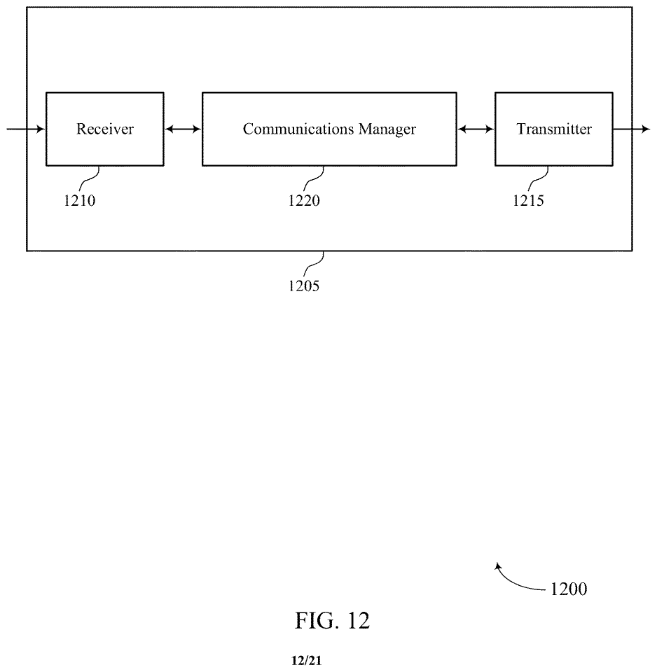

FIG. 12 shows a block diagram 1200 of a device 1205 that supports capability-based ML model quantization in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of capability-based ML model quantization as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 is capable of, configured to, or operable to support a means for receiving a first message indicating a capability of a UE to support one or more quantization schemes. The communications manager 1220 is capable of, configured to, or operable to support a means for transmitting a second message indicating whether a ML model is configured in accordance with the one or more quantization schemes based on the capability of the UE. The communications manager 1220 is capable of, configured to, or operable to support a means for receiving a report including information that is based on one or more channel estimations performed in accordance with the ML model.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for a UE to indicate a capability of the UE to perform ML model quantization, which may result in reduced processing and reduced power consumption.

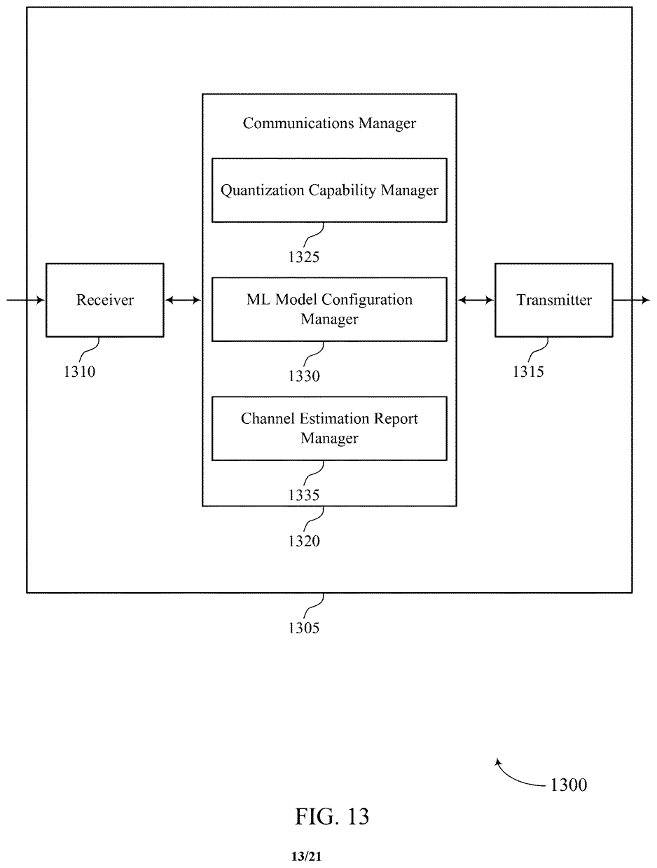

FIG. 13 shows a block diagram 1300 of a device 1305 that supports capability-based ML model quantization in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of capability-based ML model quantization as described herein. For example, the communications manager 1320 may include a quantization capability manager 1325, an ML model configuration manager 1330, a channel estimation report manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The quantization capability manager 1325 is capable of, configured to, or operable to support a means for receiving a first message indicating a capability of a UE to support one or more quantization schemes. The ML model configuration manager 1330 is capable of, configured to, or operable to support a means for transmitting a second message indicating whether a ML model is configured in accordance with the one or more quantization schemes based on the capability of the UE. The channel estimation report manager 1335 is capable of, configured to, or operable to support a means for receiving a report including information that is based on one or more channel estimations performed in accordance with the ML model.

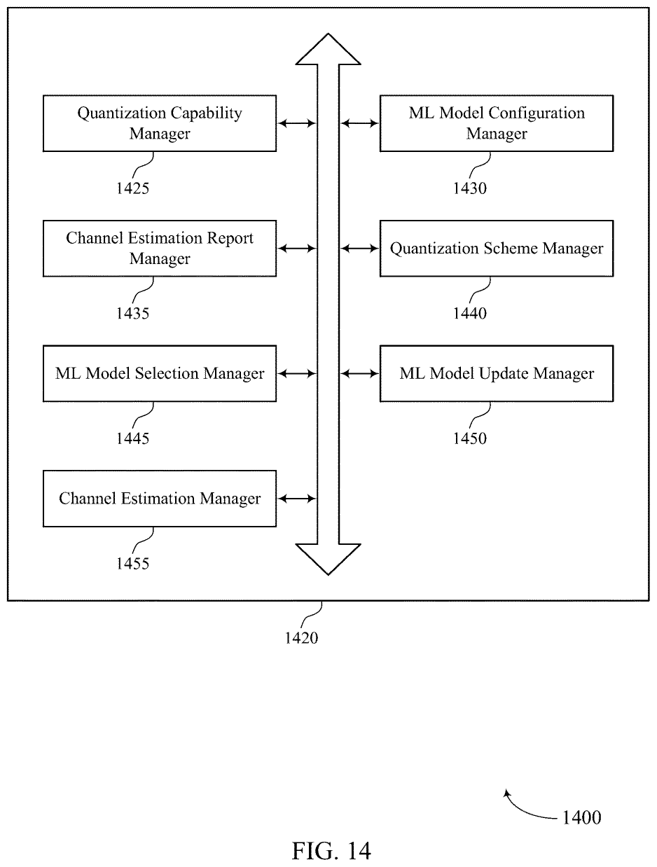

FIG. 14 shows a block diagram 1400 of a communications manager 1420 that supports capability-based ML model quantization in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of capability-based ML model quantization as described herein. For example, the communications manager 1420 may include a quantization capability manager 1425, an ML model configuration manager 1430, a channel estimation report manager 1435, a quantization scheme manager 1440, an ML model selection manager 1445, an ML model update manager 1450, a channel estimation manager 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The quantization capability manager 1425 is capable of, configured to, or operable to support a means for receiving a first message indicating a capability of a UE to support one or more quantization schemes. The ML model configuration manager 1430 is capable of, configured to, or operable to support a means for transmitting a second message indicating whether a ML model is configured in accordance with the one or more quantization schemes based on the capability of the UE. The channel estimation report manager 1435 is capable of, configured to, or operable to support a means for receiving a report including information that is based on one or more channel estimations performed in accordance with the ML model.

In some examples, the ML model configuration manager 1430 is capable of, configured to, or operable to support a means for transmitting, via the second message, an indication of a configuration for the ML model based on the capability of the UE, the configuration indicating at least one quantization scheme from of the one or more quantization schemes supported by the UE for the ML model, where the one or more channel estimations are based on the configuration.

In some examples, the ML model configuration manager 1430 is capable of, configured to, or operable to support a means for transmitting, via the second message, an indication of a configuration for the ML model based on the capability of the UE, the configuration indicating that the ML model is configured independently of a quantization scheme, where the one or more channel estimations are based on the configuration.

In some examples, the quantization scheme manager 1440 is capable of, configured to, or operable to support a means for transmitting, via the second message, an indication of a quantization configuration for the ML model based on the capability of the UE, the quantization configuration indicating a quantization scheme from of the one or more quantization schemes supported by the UE for the ML model, where the one or more channel estimations are based on the quantization configuration.

In some examples, the ML model update manager 1450 is capable of, configured to, or operable to support a means for receiving an indication of an update to the ML model based on the quantization scheme being associated with the ML model.

In some examples, the quantization scheme manager 1440 is capable of, configured to, or operable to support a means for determining a set of multiple quantization schemes based on the capability of the UE, where the quantization configuration indicates the set of multiple quantization schemes. In some examples, the quantization scheme manager 1440 is capable of, configured to, or operable to support a means for receiving an indication of the quantization scheme selected from the set of multiple quantization schemes.

In some examples, the quantization configuration indicates quantization of a parameter for the ML model, respective quantization schemes for two or more parameters, or functions, or both, of the ML model, a quantization for reporting a feature, or any combination thereof.

In some examples, the quantization capability manager 1425 is capable of, configured to, or operable to support a means for receiving, via the first message, an indication of respective performance metrics for a set of multiple versions of the ML model, an indication of a version of the ML model, or both, where the version of the ML model is from a set of multiple versions of the ML model based at least in part of the respective performance metrics, and where the second message indicates a configuration for the ML model based on the indication of the respective performance metrics, the indication of the version, or both.

In some examples, the ML model configuration manager 1430 is capable of, configured to, or operable to support a means for transmitting, via the second message, an indication of a set of multiple versions of the ML model and respective performance metrics for the set of multiple versions of the ML model. In some examples, the ML model selection manager 1445 is capable of, configured to, or operable to support a means for receiving a third message indicating a first version of the ML model selected from the set of multiple versions of the ML model based on the respective performance metrics, where the respective performance metrics correspond to the one or more quantization schemes for the ML model.

In some examples, the channel estimation manager 1455 is capable of, configured to, or operable to support a means for transmitting a fourth message indicating a set of multiple time-frequency resources corresponding to the one or more channel estimations based on the third message.

In some examples, the ML model selection manager 1445 is capable of, configured to, or operable to support a means for receiving a fifth message indicating a second version of the ML model from the set of multiple versions of the ML model, respective performance metrics for the second version of the ML model, or both.

In some examples, the quantization capability manager 1425 is capable of, configured to, or operable to support a means for receiving, via the first message, an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof, where the first message includes a capability message.

In some examples, the quantization capability manager 1425 is capable of, configured to, or operable to support a means for receiving, via the first message, a request for the ML model, the request including an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a set of multiple different quantization schemes for the ML model, an indication of a granularity of the one or more quantization schemes, or any combination thereof.

In some examples, a granularity of the one or more quantization schemes is based on whether the one or more quantization schemes correspond to respective ML models, respective layers, respective channels, respective parameter quantization, include a set of multiple different quantization schemes for the ML model, or any combination thereof.

In some examples, the one or more quantization schemes include a four bit quantization scheme, a five bit quantization scheme, an eight bit quantization scheme, a sixteen bit quantization scheme, or any combination thereof.

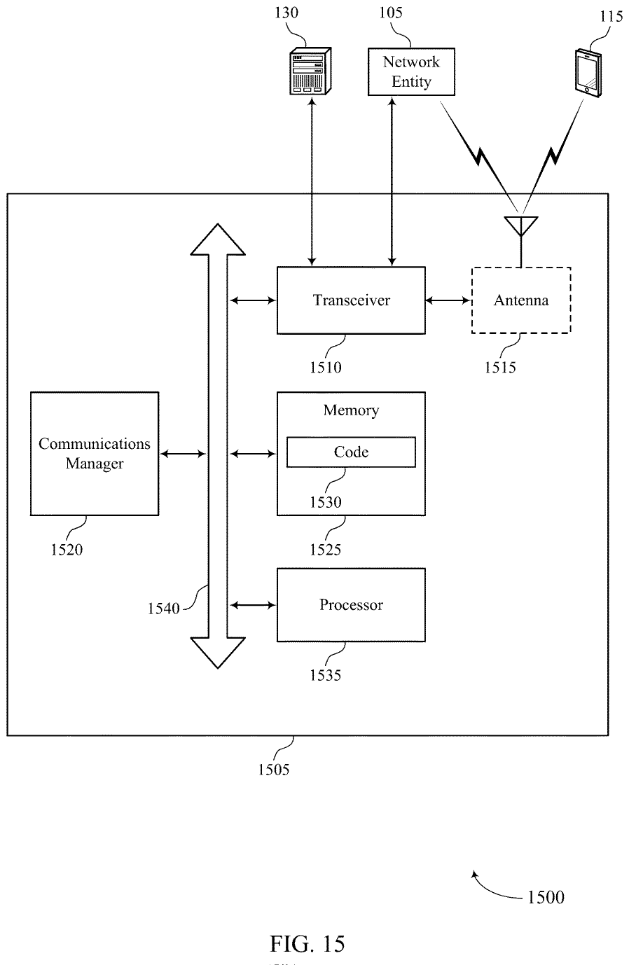

FIG. 15 shows a diagram of a system 1500 including a device 1505 that supports capability-based ML model quantization in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting capability-based ML model quantization). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 is capable of, configured to, or operable to support a means for receiving a first message indicating a capability of a UE to support one or more quantization schemes. The communications manager 1520 is capable of, configured to, or operable to support a means for transmitting a second message indicating whether a ML model is configured in accordance with the one or more quantization schemes based on the capability of the UE. The communications manager 1520 is capable of, configured to, or operable to support a means for receiving a report including information that is based on one or more channel estimations performed in accordance with the ML model.

By including or configuring the communications manager 1520 in accordance with examples as described herein, the device 1505 may support techniques for a UE to indicate a capability of the UE to perform ML model quantization, which may result in reduced latency, improved user experience related to reduced processing, reduced power consumption, improved coordination between devices, longer battery life, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of capability-based ML model quantization as described herein, or the processor 1535 and the memory 1525 may be otherwise configured to perform or support such operations.

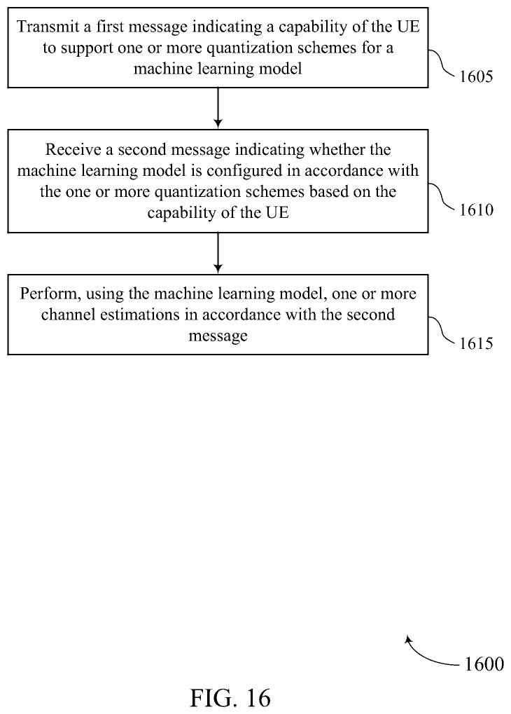

FIG. 16 shows a flowchart illustrating a method 1600 that supports capability-based ML model quantization in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include transmitting a first message indicating a capability of the UE to support one or more quantization schemes for a ML model. The operations of 1605 may be performed in accordance with examples as disclosed herein. In some examples, aspects of the operations of 1605 may be performed by a quantization capability manager 1025 as described with reference to FIG. 10.

At 1610, the method may include receiving a second message indicating whether the ML model is configured in accordance with the one or more quantization schemes based on the capability of the UE. The operations of 1610 may be performed in accordance with examples as disclosed herein. In some examples, aspects of the operations of 1610 may be performed by an ML model configuration manager 1030 as described with reference to FIG. 10.

At 1615, the method may include performing, using the ML model, one or more channel estimations in accordance with the second message. The operations of 1615 may be performed in accordance with examples as disclosed herein. In some examples, aspects of the operations of 1615 may be performed by a channel estimation manager 1035 as described with reference to FIG. 10.

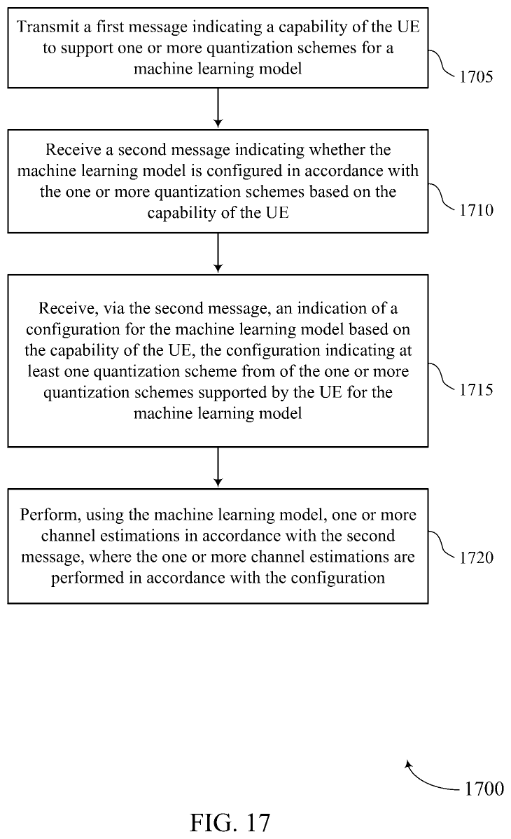

FIG. 17 shows a flowchart illustrating a method 1700 that supports capability-based ML model quantization in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include transmitting a first message indicating a capability of the UE to support one or more quantization schemes for a ML model. The operations of 1705 may be performed in accordance with examples as disclosed herein. In some examples, aspects of the operations of 1705 may be performed by a quantization capability manager 1025 as described with reference to FIG. 10.

At 1710, the method may include receiving a second message indicating whether the ML model is configured in accordance with the one or more quantization schemes based on the capability of the UE. The operations of 1710 may be performed in accordance with examples as disclosed herein. In some examples, aspects of the operations of 1710 may be performed by an ML model configuration manager 1030 as described with reference to FIG. 10.

At 1715, the method may include receiving, via the second message, an indication of a configuration for the ML model based on the capability of the UE, the configuration indicating at least one quantization scheme from of the one or more quantization schemes supported by the UE for the ML model. The operations of 1715 may be performed in accordance with examples as disclosed herein. In some examples, aspects of the operations of 1715 may be performed by an ML model configuration manager 1030 as described with reference to FIG. 10.

At 1720, the method may include performing, using the ML model, one or more channel estimations in accordance with the second message, where the one or more channel estimations are performed in accordance with the configuration. The operations of 1720 may be performed in accordance with examples as disclosed herein. In some examples, aspects of the operations of 1720 may be performed by a channel estimation manager 1035 as described with reference to FIG. 10.

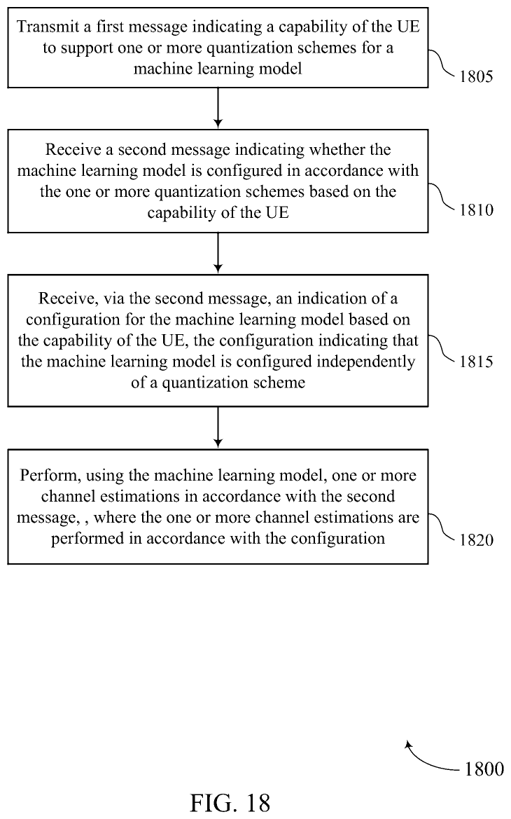

FIG. 18 shows a flowchart illustrating a method 1800 that supports capability-based ML model quantization in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1805, the method may include transmitting a first message indicating a capability of the UE to support one or more quantization schemes for a ML model. The operations of 1805 may be performed in accordance with examples as disclosed herein. In some examples, aspects of the operations of 1805 may be performed by a quantization capability manager 1025 as described with reference to FIG. 10.

At 1810, the method may include receiving a second message indicating whether the ML model is configured in accordance with the one or more quantization schemes based on the capability of the UE. The operations of 1810 may be performed in accordance with examples as disclosed herein. In some examples, aspects of the operations of 1810 may be performed by an ML model configuration manager 1030 as described with reference to FIG. 10.

At 1815, the method may include receiving, via the second message, an indication of a configuration for the ML model based on the capability of the UE, the configuration indicating that the ML model is configured independently of a quantization scheme. The operations of 1815 may be performed in accordance with examples as disclosed herein. In some examples, aspects of the operations of 1815 may be performed by an ML model configuration manager 1030 as described with reference to FIG. 10.

At 1820, the method may include performing, using the ML model, one or more channel estimations in accordance with the second message, where the one or more channel estimations are performed in accordance with the configuration. The operations of 1820 may be performed in accordance with examples as disclosed herein. In some examples, aspects of the operations of 1820 may be performed by a channel estimation manager 1035 as described with reference to FIG. 10.

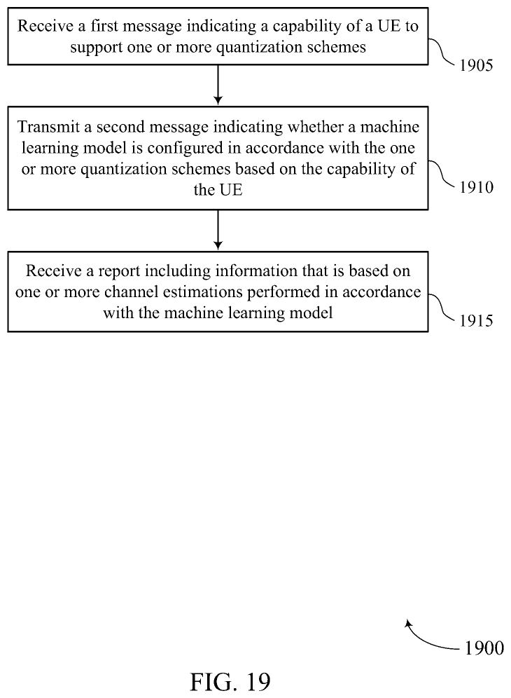

FIG. 19 shows a flowchart illustrating a method 1900 that supports capability-based ML model quantization in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include receiving a first message indicating a capability of a UE to support one or more quantization schemes. The operations of 1905 may be performed in accordance with examples as disclosed herein. In some examples, aspects of the operations of 1905 may be performed by a quantization capability manager 1425 as described with reference to FIG. 14.

At 1910, the method may include transmitting a second message indicating whether a ML model is configured in accordance with the one or more quantization schemes based on the capability of the UE. The operations of 1910 may be performed in accordance with examples as disclosed herein. In some examples, aspects of the operations of 1910 may be performed by an ML model configuration manager 1430 as described with reference to FIG. 14.

At 1915, the method may include receiving a report including information that is based on one or more channel estimations performed in accordance with the ML model. The operations of 1915 may be performed in accordance with examples as disclosed herein. In some examples, aspects of the operations of 1915 may be performed by a channel estimation report manager 1435 as described with reference to FIG. 14.

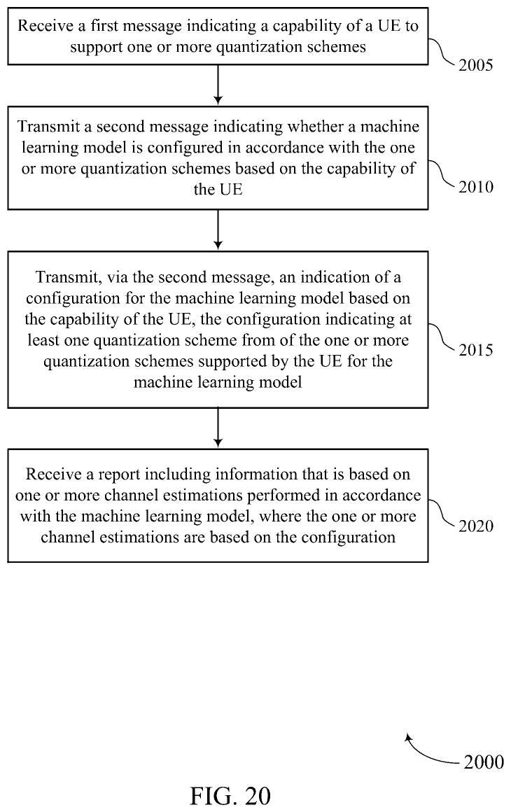

FIG. 20 shows a flowchart illustrating a method 2000 that supports capability-based ML model quantization in accordance with aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 2005, the method may include receiving a first message indicating a capability of a UE to support one or more quantization schemes. The operations of 2005 may be performed in accordance with examples as disclosed herein. In some examples, aspects of the operations of 2005 may be performed by a quantization capability manager 1425 as described with reference to FIG. 14.

At 2010, the method may include transmitting a second message indicating whether a ML model is configured in accordance with the one or more quantization schemes based on the capability of the UE. The operations of 2010 may be performed in accordance with examples as disclosed herein. In some examples, aspects of the operations of 2010 may be performed by an ML model configuration manager 1430 as described with reference to FIG. 14.

At 2015, the method may include transmitting, via the second message, an indication of a configuration for the ML model based on the capability of the UE, the configuration indicating at least one quantization scheme from of the one or more quantization schemes supported by the UE for the ML model. The operations of 2015 may be performed in accordance with examples as disclosed herein. In some examples, aspects of the operations of 2015 may be performed by an ML model configuration manager 1430 as described with reference to FIG. 14.

At 2020, the method may include receiving a report including information that is based on one or more channel estimations performed in accordance with the ML model, where the one or more channel estimations are based on the configuration. The operations of 2020 may be performed in accordance with examples as disclosed herein. In some examples, aspects of the operations of 2020 may be performed by a channel estimation report manager 1435 as described with reference to FIG. 14.

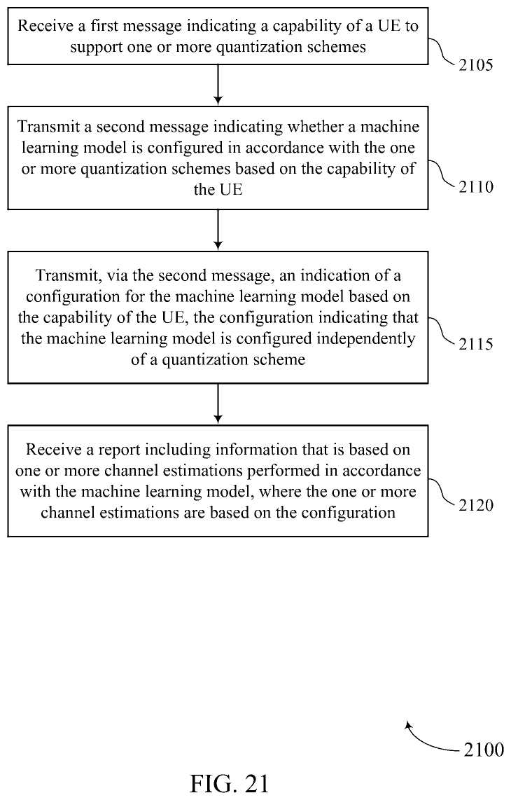

FIG. 21 shows a flowchart illustrating a method 2100 that supports capability-based ML model quantization in accordance with aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 2105, the method may include receiving a first message indicating a capability of a UE to support one or more quantization schemes. The operations of 2105 may be performed in accordance with examples as disclosed herein. In some examples, aspects of the operations of 2105 may be performed by a quantization capability manager 1425 as described with reference to FIG. 14.

At 2110, the method may include transmitting a second message indicating whether a ML model is configured in accordance with the one or more quantization schemes based on the capability of the UE. The operations of 2110 may be performed in accordance with examples as disclosed herein. In some examples, aspects of the operations of 2110 may be performed by an ML model configuration manager 1430 as described with reference to FIG. 14.

At 2115, the method may include transmitting, via the second message, an indication of a configuration for the ML model based on the capability of the UE, the configuration indicating that the ML model is configured independently of a quantization scheme. The operations of 2115 may be performed in accordance with examples as disclosed herein. In some examples, aspects of the operations of 2115 may be performed by an ML model configuration manager 1430 as described with reference to FIG. 14.

At 2120, the method may include receiving a report including information that is based on one or more channel estimations performed in accordance with the ML model, where the one or more channel estimations are based on the configuration. The operations of 2120 may be performed in accordance with examples as disclosed herein. In some examples, aspects of the operations of 2120 may be performed by a channel estimation report manager 1435 as described with reference to FIG. 14.

The following provides an overview of aspects of the present disclosure:

Aspect 1: A method for wireless communication at a UE, comprising: transmitting a first message indicating a capability of the UE to support one or more quantization schemes for a ML model; receiving a second message indicating whether the ML model is configured in accordance with the one or more quantization schemes based at least in part on the capability of the UE; and performing, using the ML model, one or more channel estimations in accordance with the second message.

Aspect 2: The method of aspect 1, further comprising: receiving, via the second message, an indication of a configuration for the ML model based at least in part on the capability of the UE, the configuration indicating at least one quantization scheme from of the one or more quantization schemes supported by the UE for the ML model, wherein the one or more channel estimations are performed in accordance with the configuration.

Aspect 3: The method of aspect 1, further comprising: receiving, via the second message, an indication of a configuration for the ML model based at least in part on the capability of the UE, the configuration indicating that the ML model is configured independently of a quantization scheme, wherein the one or more channel estimations are performed in accordance with the configuration.

Aspect 4: The method of aspect 1, further comprising: receiving, via the second message, an indication of a quantization configuration for the ML model based at least in part on the capability of the UE, the quantization configuration indicating a quantization scheme from of the one or more quantization schemes supported by the UE for the ML model, wherein the one or more channel estimations are performed in accordance with the quantization scheme.

Aspect 5: The method of aspect 4, further comprising: transmitting an indication of an update to the ML model based at least in part on applying the quantization scheme with the ML model.

Aspect 6: The method of any of aspects 4 through 5, wherein the quantization configuration indicates a plurality of quantization schemes, the method further comprising: selecting the quantization scheme from the plurality of quantization schemes to apply to the ML model; and transmitting an indication of the quantization scheme.

Aspect 7: The method of any of aspects 4 through 6, wherein the quantization configuration indicates quantization of a parameter for the ML model, respective quantization schemes for two or more parameters, or functions, or both, of the ML model, a quantization for reporting a feature, or any combination thereof.

Aspect 8: The method of any of aspects 1 through 2 or 4 through 7, further comprising: selecting a version of the ML model from a plurality of versions of the ML model based at least in part on comparing respective performance metrics for the plurality of versions of the ML model, wherein the respective performance metrics correspond to the one or more quantization schemes for the ML model; and transmitting, via the first message, an indication of the respective performance metrics, the version of the ML model, or both, wherein the capability of the UE is based at least in part on the indication, and wherein the second message indicates a configuration for the ML model based at least in part on the indication.

Aspect 9: The method of any of aspects 1 through 2 or 4 through 8, further comprising: receiving, via the second message, an indication of a plurality of versions of the ML model and respective performance metrics for the plurality of versions of the ML model; selecting a first version of the ML model from the plurality of versions of the ML model based at least in part on comparing the respective performance metrics for the plurality of versions of the ML model, wherein the respective performance metrics correspond to the one or more quantization schemes for the ML model; and transmitting a third message indicating the first version of the ML model, the respective performance metrics for the first version of the ML model, or both.

Aspect 10: The method of aspect 9, further comprising: receiving a fourth message indicating a plurality of time-frequency resources corresponding to the one or more channel estimations based at least in part on the third message.

Aspect 11: The method of any of aspects 9 through 10, further comprising: selecting a second version of the ML model from the plurality of versions of the ML model; and transmitting a fifth message indicating respective performance metrics for the second version of the ML model, the second version of the ML model, or both.

Aspect 12: The method of any of aspects 1 through 11, further comprising: transmitting, via the first message, an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a plurality of different quantization schemes for the ML model, an indication of a granularity of the one or more quantization schemes, or any combination thereof, wherein the first message comprises a capability message.

Aspect 13: The method of any of aspects 1 through 12, further comprising: transmitting, via the first message, a request for the ML model, the request including an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a plurality of different quantization schemes for the ML model, an indication of a granularity of the one or more quantization schemes, or any combination thereof.

Aspect 14: The method of any of aspects 1 through 13, wherein performing the one or more channel estimations further comprises: obtaining, from an encoder of the UE, an output corresponding to one or more reference signals; and applying the ML model to the output of the encoder in accordance with the second message.

Aspect 15: The method of any of aspects 1 through 14, wherein a granularity of the one or more quantization schemes is based at least in part on whether the one or more quantization schemes correspond to respective ML models, respective layers, respective channels, respective parameter quantization, comprise a plurality of different quantization schemes for the ML model, or any combination thereof.

Aspect 16: The method of any of aspects 1 through 15, wherein the one or more quantization schemes comprise a four bit quantization scheme, a five bit quantization scheme, an eight bit quantization scheme, a sixteen bit quantization scheme, or any combination thereof.

Aspect 17: A method for wireless communication at a network entity, comprising: receiving a first message indicating a capability of a UE to support one or more quantization schemes; transmitting a second message indicating whether a ML model is configured in accordance with the one or more quantization schemes based at least in part on the capability of the UE; and receiving a report including information that is based at least in part on one or more channel estimations performed in accordance with the ML model.

Aspect 18: The method of aspect 17, further comprising: transmitting, via the second message, an indication of a configuration for the ML model based at least in part on the capability of the UE, the configuration indicating at least one quantization scheme from of the one or more quantization schemes supported by the UE for the ML model, wherein the one or more channel estimations are based at least in part on the configuration.

Aspect 19: The method of aspect 17, further comprising: transmitting, via the second message, an indication of a configuration for the ML model based at least in part on the capability of the UE, the configuration indicating that the ML model is configured independently of a quantization scheme, wherein the one or more channel estimations are based at least in part on the configuration.

Aspect 20: The method of aspect 17, further comprising: transmitting, via the second message, an indication of a quantization configuration for the ML model based at least in part on the capability of the UE, the quantization configuration indicating a quantization scheme from of the one or more quantization schemes supported by the UE for the ML model, wherein the one or more channel estimations are based at least in part on the quantization configuration.

Aspect 21: The method of aspect 20, further comprising: receiving an indication of an update to the ML model based at least in part on the quantization scheme being associated with the ML model.

Aspect 22: The method of any of aspects 20 through 21, further comprising: determining a plurality of quantization schemes based at least in part on the capability of the UE, wherein the quantization configuration indicates the plurality of quantization schemes; and receiving an indication of the quantization scheme selected from the plurality of quantization schemes.

Aspect 23: The method of any of aspects 20 through 22, wherein the quantization configuration indicates quantization of a parameter for the ML model, respective quantization schemes for two or more parameters, or functions, or both, of the ML model, a quantization for reporting a feature, or any combination thereof.

Aspect 24: The method of any of aspects 17 through 23, further comprising: receiving, via the first message, an indication of respective performance metrics for a plurality of versions of the ML model, an indication of a version of the ML model, or both, wherein the version of the ML model is from a plurality of versions of the ML model based at least in part of the respective performance metrics, and wherein the second message indicates a configuration for the ML model based at least in part on the indication of the respective performance metrics, the indication of the version, or both.

Aspect 25: The method of any of aspects 17 through 18 or 20 through 24, further comprising: transmitting, via the second message, an indication of a plurality of versions of the ML model and respective performance metrics for the plurality of versions of the ML model; and receiving a third message indicating a first version of the ML model selected from the plurality of versions of the ML model based at least in part on the respective performance metrics, wherein the respective performance metrics correspond to the one or more quantization schemes for the ML model.

Aspect 26: The method of aspect 25, further comprising: transmitting a fourth message indicating a plurality of time-frequency resources corresponding to the one or more channel estimations based at least in part on the third message.

Aspect 27: The method of any of aspects 25 through 26, further comprising: receiving a fifth message indicating a second version of the ML model from the plurality of versions of the ML model, respective performance metrics for the second version of the ML model, or both.

Aspect 28: The method of any of aspects 17 through 27, further comprising: receiving, via the first message, an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a plurality of different quantization schemes for the ML model, an indication of a granularity of the one or more quantization schemes, or any combination thereof, wherein the first message comprises a capability message.

Aspect 29: The method of any of aspects 17 through 28, further comprising: receiving, via the first message, a request for the ML model, the request including an indication of whether the ML model is to be quantized using the one or more quantization schemes, an indication of whether the ML model being quantized using the one or more quantization schemes is supported by the UE, an indication of whether the ML model is to use the one or more quantization schemes for a function, an indication of support of a set of quantization schemes of the one or more quantization schemes, an indication of whether the UE supports a plurality of different quantization schemes for the ML model, an indication of a granularity of the one or more quantization schemes, or any combination thereof.

Aspect 30: The method of any of aspects 17 through 29, wherein a granularity of the one or more quantization schemes is based at least in part on whether the one or more quantization schemes correspond to respective ML models, respective layers, respective channels, respective parameter quantization, comprise a plurality of different quantization schemes for the ML model, or any combination thereof.

Aspect 31: The method of any of aspects 17 through 30, wherein the one or more quantization schemes comprise a four bit quantization scheme, a five bit quantization scheme, an eight bit quantization scheme, a sixteen bit quantization scheme, or any combination thereof.

Aspect 32: An apparatus for wireless communication at a UE, comprising a processor; memory coupled with the processor; and instructions stored in the memory and executable by the processor to cause the apparatus to perform a method of any of aspects 1 through 16.

Aspect 33: An apparatus for wireless communication at a UE, comprising at least one means for performing a method of any of aspects 1 through 16.

Aspect 34: A non-transitory computer-readable medium storing code for wireless communication at a UE, the code comprising instructions executable by a processor to perform a method of any of aspects 1 through 16.

Aspect 35: An apparatus for wireless communication at a network entity, comprising a processor; memory coupled with the processor; and instructions stored in the memory and executable by the processor to cause the apparatus to perform a method of any of aspects 17 through 31.

Aspect 36: An apparatus for wireless communication at a network entity, comprising at least one means for performing a method of any of aspects 17 through 31.

Aspect 37: A non-transitory computer-readable medium storing code for wireless communication at a network entity, the code comprising instructions executable by a processor to perform a method of any of aspects 17 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
transmit a first message indicating a capability of the UE to support one or more quantization schemes for a machine learning model;
receive a second message indicating whether the machine learning model is configured in accordance with the one or more quantization schemes based at least in part on the capability of the UE; and
perform, using the machine learning model, one or more channel estimations in accordance with the second message.

2. The apparatus of claim 1, wherein the instructions are further executable by the processor to cause the apparatus to:
receive, via the second message, an indication of a configuration for the machine learning model based at least in part on the capability of the UE, the configuration indicating at least one quantization scheme from of the one or more quantization schemes supported by the UE for the machine learning model, wherein the one or more channel estimations are performed in accordance with the configuration.

3. The apparatus of claim 1, wherein the instructions are further executable by the processor to cause the apparatus to:
receive, via the second message, an indication of a configuration for the machine learning model based at least in part on the capability of the UE, the configuration indicating that the machine learning model is configured independently of a quantization scheme, wherein the one or more channel estimations are performed in accordance with the configuration.

4. The apparatus of claim 1, wherein the instructions are further executable by the processor to cause the apparatus to:
receive, via the second message, an indication of a quantization configuration for the machine learning model based at least in part on the capability of the UE, the quantization configuration indicating a quantization scheme from of the one or more quantization schemes supported by the UE for the machine learning model, wherein the one or more channel estimations are performed in accordance with the quantization scheme.

5. (canceled)

6. (canceled)

7. (canceled)

8. The apparatus of claim 1, wherein the instructions are further executable by the processor to cause the apparatus to:
select a version of the machine learning model from a plurality of versions of the machine learning model based at least in part on comparing respective performance metrics for the plurality of versions of the machine learning model, wherein the respective performance metrics correspond to the one or more quantization schemes for the machine learning model; and
transmit, via the first message, an indication of the respective performance metrics, the version of the machine learning model, or both, wherein the capability of the UE is based at least in part on the indication, and wherein the second message indicates a configuration for the machine learning model based at least in part on the indication.

9. The apparatus of claim 1, wherein the instructions are further executable by the processor to cause the apparatus to:
receive, via the second message, an indication of a plurality of versions of the machine learning model and respective performance metrics for the plurality of versions of the machine learning model;
select a first version of the machine learning model from the plurality of versions of the machine learning model based at least in part on comparing the respective performance metrics for the plurality of versions of the machine learning model, wherein the respective performance metrics correspond to the one or more quantization schemes for the machine learning model; and
transmit a third message indicating the first version of the machine learning model, the respective performance metrics for the first version of the machine learning model, or both.

10. (canceled)

11. (canceled)

12. The apparatus of claim 1, wherein the instructions are further executable by the processor to cause the apparatus to:
transmit, via the first message, an indication of whether the machine learning model is to be quantized using the one or more quantization schemes, an indication of whether the machine learning model being quantized using the one or more quantization schemes is supported by the UE, an indication of whether the machine learning model is to use the one or more quantization schemes for a function, an indication of support of a set of quantization schemes of the one or more quantization schemes, an indication of whether the UE supports a plurality of different quantization schemes for the machine learning model, an indication of a granularity of the one or more quantization schemes, or any combination thereof, wherein the first message comprises a capability message.

13. The apparatus of claim 1, wherein the instructions are further executable by the processor to cause the apparatus to:
transmit, via the first message, a request for the machine learning model, the request including an indication of whether the machine learning model is to be quantized using the one or more quantization schemes, an indication of whether the machine learning model being quantized using the one or more quantization schemes is supported by the UE, an indication of whether the machine learning model is to use the one or more quantization schemes for a function, an indication of support of a set of quantization schemes of the one or more quantization schemes, an indication of whether the UE supports a plurality of different quantization schemes for the machine learning model, an indication of a granularity of the one or more quantization schemes, or any combination thereof.

14. The apparatus of claim 1, wherein the instructions to perform the one or more channel estimations are further executable by the processor to cause the apparatus to:
obtain, from an encoder of the UE, an output corresponding to one or more reference signals; and
apply the machine learning model to the output of the encoder in accordance with the second message.

15. The apparatus of claim 1, wherein a granularity of the one or more quantization schemes is based at least in part on whether the one or more quantization schemes correspond to respective machine learning models, respective layers, respective channels, respective parameter quantization, comprise a plurality of different quantization schemes for the machine learning model, or any combination thereof.

16. The apparatus of claim 1, wherein the one or more quantization schemes comprise a four bit quantization scheme, a five bit quantization scheme, an eight bit quantization scheme, a sixteen bit quantization scheme, or any combination thereof.

17. An apparatus for wireless communication at a network entity, comprising:
a processor;
memory coupled with the processor; and
instructions stored in the memory and executable by the processor to cause the apparatus to:
receive a first message indicating a capability of a user equipment (UE) to support one or more quantization schemes;
transmit a second message indicating whether a machine learning model is configured in accordance with the one or more quantization schemes based at least in part on the capability of the UE; and
receive a report including information that is based at least in part on one or more channel estimations performed in accordance with the machine learning model.

18. The apparatus of claim 17, wherein the instructions are further executable by the processor to cause the apparatus to:
transmit, via the second message, an indication of a configuration for the machine learning model based at least in part on the capability of the UE, the configuration indicating at least one quantization scheme from of the one or more quantization schemes supported by the UE for the machine learning model, wherein the one or more channel estimations are based at least in part on the configuration.

19. The apparatus of claim 17, wherein the instructions are further executable by the processor to cause the apparatus to:
transmit, via the second message, an indication of a configuration for the machine learning model based at least in part on the capability of the UE, the configuration indicating that the machine learning model is configured independently of a quantization scheme, wherein the one or more channel estimations are based at least in part on the configuration.

20. The apparatus of claim 17, wherein the instructions are further executable by the processor to cause the apparatus to:
transmit, via the second message, an indication of a quantization configuration for the machine learning model based at least in part on the capability of the UE, the quantization configuration indicating a quantization scheme from of the one or more quantization schemes supported by the UE for the machine learning model, wherein the one or more channel estimations are based at least in part on the quantization configuration.

21. (canceled)

22. The apparatus of claim 20, wherein the instructions are further executable by the processor to cause the apparatus to:
determine a plurality of quantization schemes based at least in part on the capability of the UE, wherein the quantization configuration indicates the plurality of quantization schemes; and
receive an indication of the quantization scheme selected from the plurality of quantization schemes.

23. The apparatus of claim 20, wherein the quantization configuration indicates quantization of a parameter for the machine learning model, respective quantization schemes for two or more parameters, or functions, or both, of the machine learning model, a quantization for reporting a feature, or any combination thereof.

24. The apparatus of claim 17, wherein the instructions are further executable by the processor to cause the apparatus to:
receive, via the first message, an indication of respective performance metrics for a plurality of versions of the machine learning model, an indication of a version of the machine learning model, or both, wherein the version of the machine learning model is from a plurality of versions of the machine learning model based at least in part of the respective performance metrics, and wherein the second message indicates a configuration for the machine learning model based at least in part on the indication of the respective performance metrics, the indication of the version, or both.

25. The apparatus of claim 17, wherein the instructions are further executable by the processor to cause the apparatus to:
transmit, via the second message, an indication of a plurality of versions of the machine learning model and respective performance metrics for the plurality of versions of the machine learning model; and
receive a third message indicating a first version of the machine learning model selected from the plurality of versions of the machine learning model based at least in part on the respective performance metrics, wherein the respective performance metrics correspond to the one or more quantization schemes for the machine learning model.

26. (canceled)

27. (canceled)

28. (canceled)

29. A method for wireless communication at a user equipment (UE), comprising:
transmitting a first message indicating a capability of the UE to support one or more quantization schemes for a machine learning model;
receiving a second message indicating whether the machine learning model is configured in accordance with the one or more quantization schemes based at least in part on the capability of the UE; and
performing, using the machine learning model, one or more channel estimations in accordance with the second message.

30. (canceled)
